(19) United States
(12) Patent Application Publication
(10) Pub. No.: US 2026/0188204 A1
(43) Pub. Date: Jul. 2, 2026

(54) EMISSION DRIVER AND ELECTRONIC DEVICE INCLUDING THE SAME

(71) Applicant: Samsung Display Co., LTD., Yongin-si, Gyeonggi-do (KR)

(72) Inventors: SEHYUN LEE, Yongin-si (KR); KYUNGHOON CHUNG, Yongin-si (KR); KWIHYUN KIM, Yongin-si (KR); JI-SUN KIM, Yongin-si (KR); SUNHWA LEE, Yongin-si (KR); MINJAE JEONG, Yongin-si (KR)

(21) Appl. No.: 19/356,330

(22) Filed: Oct. 13, 2025

(30) Foreign Application Priority Data
Dec. 27, 2024 (KR) 10-2024-0197875

(51) Int. Cl. G09G 3/3225; G09G 3/32

(52) U.S. Cl. CPC G09G 3/3225; G09G 3/32; G09G 2310/0286; G09G 2310/08; G09G 2320/0626; G09G 2330/021

(57) ABSTRACT

An emission driver includes stages. A stage of the stages includes an input circuit which transfers an input signal to a first node in response to a first clock signal, a node separation circuit which is connected between the first node and a second node and receives a low gate voltage, a node control circuit which controls a voltage of a third node based on a voltage of the first node, a high gate voltage and the low gate voltage, and an output circuit which outputs the high gate voltage as an emission signal in response to the voltage of the third node, outputs the low gate voltage as the emission signal in response to a voltage of the second node in a first mode, and outputs a second clock signal as the emission signal in response to the voltage of the second node in a second mode.

This application claims priority to Korean Patent Application No. 10-2024-0197875, filed on Dec. 27, 2024, and all the benefits accruing therefrom under 35 U.S.C. § 119, the content of which in its entirety is herein incorporated by reference.

### BACKGROUND

### 1. Field

Embodiments relate generally to display devices, and more particularly to an emission driver, and an electronic device including the emission driver.

### 2. Description of the Related Art

A display device may include a display panel that includes a plurality of pixels, a data driver that provides data signals to the plurality of pixels, a scan driver that provides scan signals to the plurality of pixels, an emission driver that provides emission signals to the plurality of pixels, and a controller that controls the data driver, the scan driver and the emission driver. The plurality of pixels may emit light in response to the emission signals generated by the emission driver.

To adjust a dimming level (or a luminance level) of the display device, a dimming technique is being developed which adjusts a time length of an emission period of each pixel within each frame period. To implement this dimming technique, the emission driver may adjust a time length of an on-period (e.g., a low period) of the emission signal according to a display brightness value (“DBV”).

### SUMMARY

However, a conventional emission driver may not adjust the time length of the on-period of the emission signal to less than two horizontal time periods, and thus may not be suitable for a low luminance mode in which the time length of the emission period is desired to be less than one horizontal time period.

Some embodiments provide an emission driver suitable for both a high luminance mode and a low luminance mode.

Some embodiments provide an electronic device including an emission driver suitable for both a high luminance mode and a low luminance mode.

In an embodiment of the disclosure, there is provided an emission driver including a plurality of stages. At least one stage of the plurality of stages includes an input circuit which transfers an input signal to a first node in response to a first clock signal, a node separation circuit connected between the first node and a second node, and receives a low gate voltage having a first voltage level, a node control circuit which controls a voltage of a third node based on a voltage of the first node, a high gate voltage having a second voltage level higher than the first voltage level and the low gate voltage, and an output circuit which outputs the high gate voltage as an emission signal in response to the voltage of the third node, outputs the low gate voltage as the emission signal in response to a voltage of the second node in a first mode, and outputs a second clock signal different from the first clock signal as the emission signal in response to the voltage of the second node in a second mode.

In an embodiment, the output circuit may output the emission signal having a low period, in which the emission signal has the first voltage level, longer than or equal to two horizontal time periods in the first mode, and may output the emission signal having a low period shorter than or equal to one horizontal time period in the second mode.

In an embodiment, the first mode may be a high luminance mode in which a display brightness value is greater than or equal to a reference value, and the second mode may be a low luminance mode in which the display brightness value is less than the reference value.

In an embodiment, the second clock signal may be delayed by half a clock period from the first clock signal.

In an embodiment, the clock period may correspond to two horizontal time periods, and the second clock signal may be delayed by one horizontal time period from the first clock signal.

In an embodiment, the input circuit may include a first transistor including a gate which receives the first clock signal, a first terminal which receives the input signal, and a second terminal connected to the first node.

In an embodiment, the node separation circuit may include a second transistor including a gate which receives the low gate voltage, a first terminal connected to the first node, and a second terminal connected to the second node.

In an embodiment, the output circuit may include a third transistor including a gate connected to the third node, a first terminal which receives the high gate voltage, and a second terminal connected to an output node from which the emission signal is output, a first capacitor including a first electrode connected to the second node, and a second electrode connected to the output node, and a fourth transistor including a gate connected to the second node, a first terminal connected to the output node, and a second terminal which receives the low gate voltage in the first mode and receives the second clock signal in the second mode.

In an embodiment, the node control circuit may include a fifth transistor including a gate connected to the first node, a first terminal which receives the high gate voltage, and a second terminal connected to the third node, a sixth transistor including a gate connected to the second node, a first terminal connected to the third node, and a second terminal which receives the low gate voltage, and a second capacitor including a first electrode which receives the high gate voltage, and a second electrode connected to the third node.

In an embodiment, the fifth transistor may be a P-type metal-oxide-semiconductor transistor, and the sixth transistor may be an N-type metal-oxide-semiconductor transistor.

In an embodiment, the at least one stage may further include a carry circuit which outputs the high gate voltage as a carry signal in response to the voltage of the third node, outputs the low gate voltage as the carry signal in response to the voltage of the second node in the first mode, and outputs the second clock signal as the carry signal in response to the voltage of the second node in the second mode.

In an embodiment, the carry circuit may include a seventh transistor including a gate connected to the third node, a first terminal which receives the high gate voltage, and a second terminal connected to a carry node from which the carry signal is output, and an eighth transistor including a gate connected to the second node, a first terminal connected to the carry node, and a second terminal which receives the low gate voltage in the first mode and receives the second clock signal in the second mode.

In an embodiment, the at least one stage may further include a carry circuit which outputs the high gate voltage as a carry signal in response to the voltage of the third node, outputs a small low gate voltage having an absolute value less than an absolute value of the low gate voltage as the carry signal in response to the voltage of the second node in the first mode, and outputs a third clock signal as the carry signal in response to the voltage of the second node in the second mode. The third clock signal may have a phase substantially equal to a phase of the second clock signal, and may have the small low gate voltage as a low voltage.

In an embodiment, the node control circuit may include a fifth transistor which applies the high gate voltage to a fourth node in response to the input signal, a sixth transistor which applies the first clock signal to the third node in response to a voltage of the fourth node, a third capacitor including a first electrode connected to the fourth node, and a second electrode which receives the first clock signal, a seventh transistor which is turned off in the first mode, and applies the first clock signal to the third node in the second mode, an eighth transistor which is turned on in the first mode, and is turned off in the second mode, a ninth transistor connected in series with the eighth transistor which is disposed between a line which transfers the high gate voltage and the third node, and applies the high gate voltage to the third node in response to the voltage of the first node in the first mode, and a second capacitor including a first electrode which receives the high gate voltage, and a second electrode connected to the third node.

In an embodiment, the fifth transistor may include a gate which receives the input signal, a first terminal which receives the high gate voltage, and a second terminal connected to the fourth node, the sixth transistor may include a gate connected to the fourth node, a first terminal connected to the third node, and a second terminal which receives the first clock signal, the seventh transistor may include a gate which receives the high gate voltage in the first mode and receives the low gate voltage in the second mode, a first terminal connected to the third node, and a second terminal which receives the first clock signal, the eighth transistor may include a gate which receives the low gate voltage in the first mode and receives the high gate voltage in the second mode, a first terminal which receives the high gate voltage, and a second terminal, and the ninth transistor may include a gate connected to the first node, a first terminal connected to the second terminal of the eighth transistor, and a second terminal connected to the third node.

In an embodiment, the fifth, sixth, seventh, eighth and ninth transistors may be P-type metal-oxide-semiconductor transistors.

In an embodiment of the disclosure, there is provided an electronic device including a processor which provides input image data, and a display device which receives the input image data from the processor, and displays an image based on the input image data. The display device includes a display panel including a plurality of pixels, a data driver which provides data signals to the plurality of pixels, a scan driver which provides scan signals to the plurality of pixels, an emission driver including a plurality of stages that sequentially provides emission signals to the plurality of pixels, and a controller which controls the data driver, the scan driver and the emission driver. At least one stage of the plurality of stages includes an input circuit which transfers an input signal to a first node in response to a first clock signal, a node separation circuit which is connected between the first node and a second node, and receives a low gate voltage having a first voltage level, a node control circuit which controls a voltage of a third node based on a voltage of the first node, a high gate voltage having a second voltage level higher than the first voltage level and the low gate voltage, and an output circuit which outputs the high gate voltage as a corresponding emission signal among the emission signals in response to the voltage of the third node, outputs the low gate voltage as the corresponding emission signal in response to a voltage of the second node in a first mode, and outputs a second clock signal different from the first clock signal as the corresponding emission signal in response to the voltage of the second node in a second mode.

In an embodiment, the controller may receive a display brightness value, may determine a mode of the display device as the first mode when the display brightness value is greater than or equal to a reference brightness value, and may determine the mode of the display device as the second mode when the display brightness value is less than the reference brightness value.

In an embodiment, the controller may provide the emission driver with a start signal having a low period, in which the emission signals have the first voltage level, longer than or equal to two horizontal time periods in the first mode, and may provide the emission driver with the start signal having a low period shorter than or equal to one horizontal time period in the second mode.

In an embodiment, in the first mode, the controller may provide the low gate voltage to output circuits of the plurality of stages. In the second mode, the controller may provide one of the first clock signal and the second clock signal to output circuits of odd-numbered stages among the output circuits of the plurality of stages, and may provide a remaining (the other) one of the first clock signal and the second clock signal to output circuits of even-numbered stages among the output circuits of the plurality of stages.

As described above, in an emission driver and an electronic device in embodiments, an output circuit of at least one stage may output a low gate voltage as an emission signal in a first mode (e.g., a high luminance mode), and may output a clock signal as the emission signal in a second mode (e.g., a low luminance mode). Accordingly, the emission driver may be suitable for not only the high luminance mode in which an on-period (e.g., a low period) of the emission signal is longer than or equal to two horizontal time periods, but also the low luminance mode in which the on-period of the emission signal is shorter than or equal to one horizontal time period.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating an embodiment of an emission driver.

FIG. 2 is a timing diagram for describing an embodiment of an operation of an emission driver in a first mode.

FIG. 3 is a timing diagram for describing an embodiment of an operation of an emission driver in a second mode.

FIG. 4 is a timing diagram for describing another embodiment of an operation of an emission driver in a second mode.

FIG. 5 is a circuit diagram illustrating an embodiment of a stage of an emission driver.

FIG. 6 is a timing diagram for describing an embodiment of an operation of a stage of FIG. 5 in a first mode.

FIG. 7 is a circuit diagram for describing an embodiment of an operation of a stage of FIG. 5 in a first time period.

FIG. 8 is a circuit diagram for describing an embodiment of an operation of a stage of FIG. 5 in a second time period.

FIG. 9 is a circuit diagram for describing an embodiment of an operation of a stage of FIG. 5 in a third time period.

FIG. 10 is a circuit diagram for describing an embodiment of an operation of a stage of FIG. 5 in a fourth time period.

FIG. 11 is a timing diagram for describing an embodiment of an operation of a stage of FIG. 5 in a second mode.

FIG. 12 is a circuit diagram for describing an embodiment of an operation of a stage of FIG. 5 in a fifth time period.

FIG. 13 is a circuit diagram for describing an embodiment of an operation of a stage of FIG. 5 in a sixth time period.

FIG. 14 is a circuit diagram for describing an embodiment of an operation of a stage of FIG. 5 in a seventh time period.

FIG. 15 is a circuit diagram illustrating an embodiment of a stage of an emission driver.

FIG. 16 is a timing diagram for describing an embodiment of an operation of a stage of FIG. 15 in a first mode.

FIG. 17 is a timing diagram for describing an embodiment of an operation of a stage of FIG. 15 in a second mode.

FIG. 18 is a circuit diagram illustrating an embodiment of a stage of an emission driver.

FIG. 19 is a timing diagram for describing an embodiment of an operation of a stage of FIG. 18 in a first mode.

FIG. 20 is a timing diagram for describing an embodiment of an operation of a stage of FIG. 18 in a second mode.

FIG. 21 is a circuit diagram illustrating an embodiment of a stage of an emission driver.

FIG. 22 is a circuit diagram for describing an embodiment of an operation of a stage of FIG. 21 in a first time period.

FIG. 23 is a circuit diagram for describing an embodiment of an operation of a stage of FIG. 21 in a second time period.

FIG. 24 is a circuit diagram for describing an embodiment of an operation of a stage of FIG. 21 in a third time period.

FIG. 25 is a circuit diagram for describing an embodiment of an operation of a stage of FIG. 21 in a fourth time period.

FIG. 26 is a timing diagram for describing an embodiment of an operation of a stage of FIG. 21 in a second mode.

FIG. 27 is a circuit diagram for describing an embodiment of an operation of a stage of FIG. 21 in a fifth time period.

FIG. 28 is a circuit diagram for describing an embodiment of an operation of a stage of FIG. 21 in a sixth time period.

FIG. 29 is a circuit diagram for describing an embodiment of an operation of a stage of FIG. 21 in a seventh time period.

FIG. 30 is a block diagram illustrating an embodiment of a display device including an emission driver.

FIG. 31 is a block diagram illustrating an embodiment of an electronic device including a display device.

### DETAILED DESCRIPTION

The embodiments are described more fully hereinafter with reference to the accompanying drawings. Like or similar reference numerals refer to like or similar elements throughout.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms “first,” “second,” “third” etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element′s relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

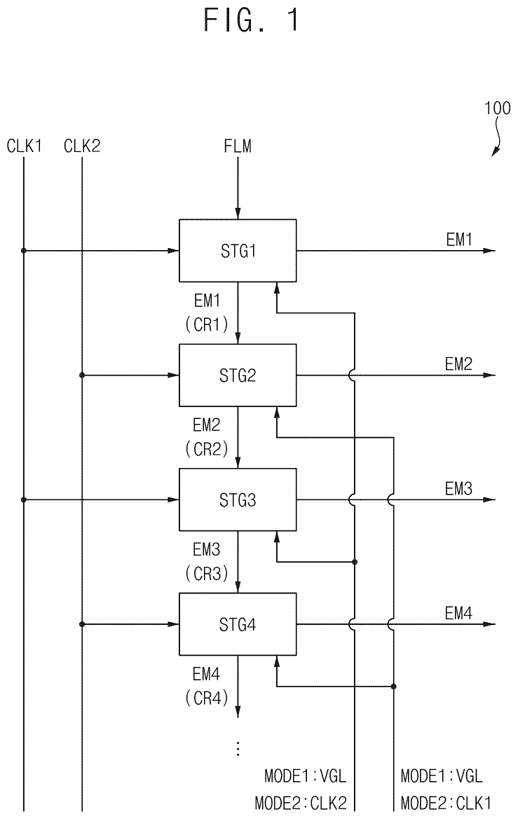

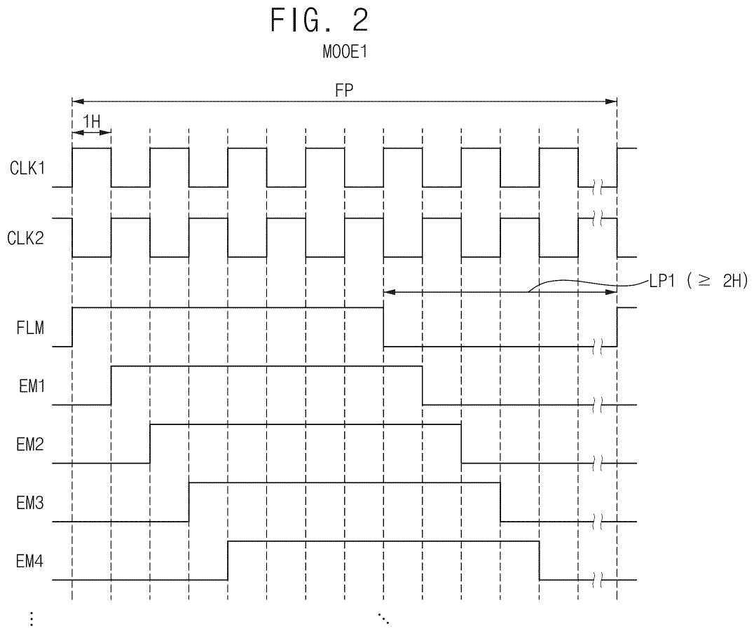

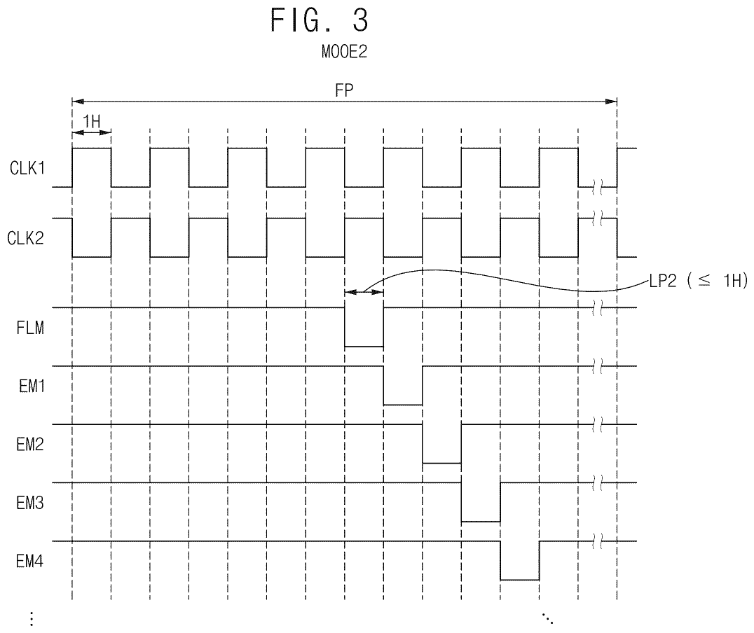

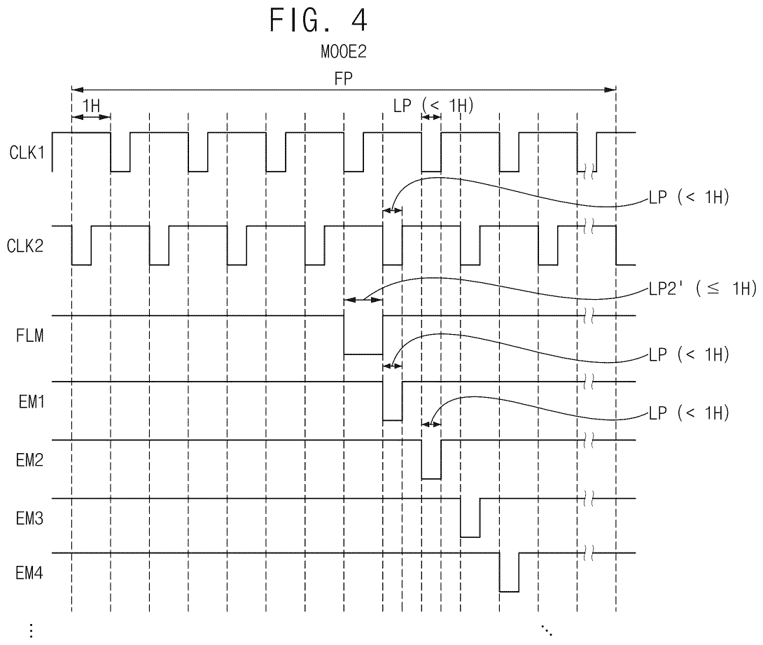

FIG. 1 is a block diagram illustrating an embodiment of an emission driver, FIG. 2 is a timing diagram for describing an embodiment of an operation of an emission driver in a first mode, FIG. 3 is a timing diagram for describing an embodiment of an operation of an emission driver in a second mode, and FIG. 4 is a timing diagram for describing another embodiment of an operation of an emission driver in a second mode.

Referring to FIG. 1, an emission driver 100 in embodiments may include a plurality of stages STG1, STG2, STG3, STG4, etc. The emission driver 100 may be implemented as a shift register in which the plurality of stages STG1, STG2, STG3, STG4, etc., sequentially outputs emission signals EM1, EM2, EM3, EM4, etc. In some embodiments, the emission driver 100 may be formed on a display panel of a display device. In an embodiment, the emission driver 100 may be integrated or formed on a substrate of the display panel, for example, but is not limited thereto.

The plurality of stages STG1, STG2, STG3, STG4, etc., may sequentially output the emission signals EM1, EM2, EM3, EM4, etc. based on a start signal FLM, a first clock signal CLK1 and a second clock signal CLK2. A first stage STG1 may receive the start signal FLM as an input signal. In some embodiments, each of subsequent stages STG2, STG3, STG4, etc., may receive the emission signal EM1, EM2, EM3, EM4, etc., of a previous stage as an input signal. In an embodiment, a second stage STG2 may receive a first emission signal EM1 of the first stage STG1 as an input signal, a third stage STG3 may receive a second emission signal EM2 of the second stage STG2 as an input signal, and a fourth stage STG4 may receive a third emission signal EM3 of the third stage STG3 as an input signal, for example. In other embodiments, each of the subsequent stages STG2, STG3, STG4, etc., may receive carry signals CR1, CR2, CR3, CR4, etc., of the previous stage as the input signal, for example. In an embodiment, the second stage STG2 may receive a first carry signal CR1 of the first stage STG1 as the input signal, the third stage STG3 may receive a second carry signal CR2 of the second stage STG2 as the input signal, and the fourth stage STG4 may receive a third carry signal CR3 of the third stage STG3 as the input signal, for example.

In some embodiments, each odd-numbered stage STG1, STG3, etc., may receive the input signal in response to the first clock signal CLK1, and each even-numbered stage STG2, STG4, etc., may receive the input signal in response to the second clock signal CLK2. Further, in some embodiments, the second clock signal CLK2 may be a signal delayed by half a clock period from the first clock signal CLK1. In an embodiment, the clock period (or a clock cycle) of the first and second clock signals CLK1 and CLK2 may correspond to two horizontal time periods, and the second clock signal CLK2 may be a signal delayed by one horizontal time period from the first clock signal CLK1, for example.

The emission driver 100 in embodiments may output the emission signals EM1, EM2, EM3, EM4, etc., having a low period LP1 that is longer than or equal to two horizontal time periods 2H in a first mode MODE1 as illustrated in FIG. 2, and may output the emission signals EM1, EM2, EM3, EM4, etc., having a low period LP2 that is shorter than or equal to one horizontal time period 1H in a second mode MODE2 as illustrated in FIG. 3. In an embodiment, one horizontal time period 1H may be a time allocated to one pixel row of the display panel, and may have a time length determined by dividing a time length of one frame period FP by the number of pixel rows of the display panel, for example. In some embodiments, the first mode MODE1 may be a high luminance mode in which a display brightness value (“DBV”) is greater than or equal to a reference value, and the second mode MODE2 may be a low luminance mode in which the DBV is less than the reference value. Here, the DBV may represent a luminance of the display device corresponding to a maximum gray level (e.g., a 255-gray level).

In an embodiment, as illustrated in FIG. 2, in the first mode MODE1, the first stage STG1 may receive a start signal FLM having a low period LP1 longer than or equal to two horizontal time periods 2H, and may output the first emission signal EM1 having the low period LP1 longer than or equal to two horizontal time periods 2H by delaying the start signal FLM by one horizontal time period 1H, for example. Further, the second stage STG2 may output the second emission signal EM2 having the low period LP1 longer than or equal to two horizontal time periods 2H by delaying the first emission signal EM1 by one horizontal time period 1H, the third stage STG3 may output the third emission signal EM3 having the low period LP1 longer than or equal to two horizontal time periods 2H by delaying the second emission signal EM2 by one horizontal time period 1H, and the fourth stage STG4 may output a fourth emission signal EM4 having the low period LP1 longer than or equal to two horizontal time periods 2H by delaying the third emission signal EM3 by one horizontal time period 1H. In this manner, in the first mode MODE1, the plurality of stages STG1, STG2, STG3, STG4, etc., may sequentially output the emission signals EM1, EM2, EM3, EM4, etc., having the low period LP1 longer than or equal to two horizontal time periods 2H by delaying or shifting the input signal by one horizontal time period 1H (or by half the clock period of the first and second clock signals CLK1 and CLK2). Further, in some embodiments, in the first mode MODE1, as the DBV increases, to increase an emission time of each pixel within the frame period FP, a time length of the low period LP1 of the start signal FLM may be increased, and the plurality of stages STG1, STG2, STG3, STG4, etc., may output the emission signals EM1, EM2, EM3, EM4, etc., having the low period LP1 of which the time length is increased (e.g., in units of two horizontal time periods 2H) based on the start signal FLM having the low period LP1 of which the time length is increased.

Further, as illustrated in FIG. 3, in the second mode MODE2, the first stage STG1 may receive a start signal FLM having a low period LP2 shorter than or equal to one horizontal time period 1H, and may output the first emission signal EM1 having the low period LP2 shorter than or equal to one horizontal time period 1H by delaying the start signal FLM by one horizontal time period 1H. Further, the second stage STG2 may the second stage STG2 may output the second emission signal EM2 having the low period LP2 shorter than or equal to one horizontal time period 1H by delaying the first emission signal EM1 by one horizontal time period 1H, the third stage STG3 may output the third emission signal EM3 having the low period LP2 shorter than or equal to one horizontal time period 1H by delaying the second emission signal EM2 by one horizontal time period 1H, and the fourth stage STG4 may output the fourth emission signal EM4 having the low period LP2 shorter than or equal to one horizontal time period 1H by delaying the third emission signal EM3 by one horizontal time period 1H. In this manner, in the second mode MODE2, the plurality of stages STG1, STG2, STG3, STG4, etc., may sequentially output the emission signals EM1, EM2, EM3, EM4, etc., having the low period LP2 shorter than or equal to one horizontal time period 1H by delaying or shifting the input signal by one horizontal time period 1H (or by half the clock period of the first and second clock signals CLK1 and CLK2).

Although FIG. 3 illustrates an embodiment in which the plurality of stages STG1, STG2, STG3, STG4, etc., outputs the emission signals EM1, EM2, EM3, EM4, etc., having a low period LP2 corresponding to one horizontal time period 1H, the plurality of stages STG1, STG2, STG3, STG4, etc., may output the emission signals EM1, EM2, EM3, EM4, etc., having a low period LP2 shorter than one horizontal time period 1H. In an embodiment, as the DBV decreases, as illustrated in FIG. 4, the plurality of stages STG1, STG2, STG3, STG4, etc., may receive the first and second clock signals CLK1 and CLK2 having a low period LP shorter than one horizontal time period 1H, and may output the emission signals EM1, EM2, EM3, EM4, etc., having the low period LP shorter than one horizontal time period 1H, for example. That is, in the second mode MODE2, as the DBV decreases, to decrease the emission time of each pixel within the frame period FP, the plurality of stages STG1, STG2, STG3, STG4, etc., may output the emission signals EM1, EM2, EM3, EM4, etc., having the low period LP shorter than one horizontal time period 1H based on the first and second clock signals CLK1 and CLK2 having the low period LP shorter than one horizontal time period 1H. In this case, the start signal FLM may have the low period LP2′ corresponding to one horizontal time period 1H or shorter than one horizontal time period 1H.

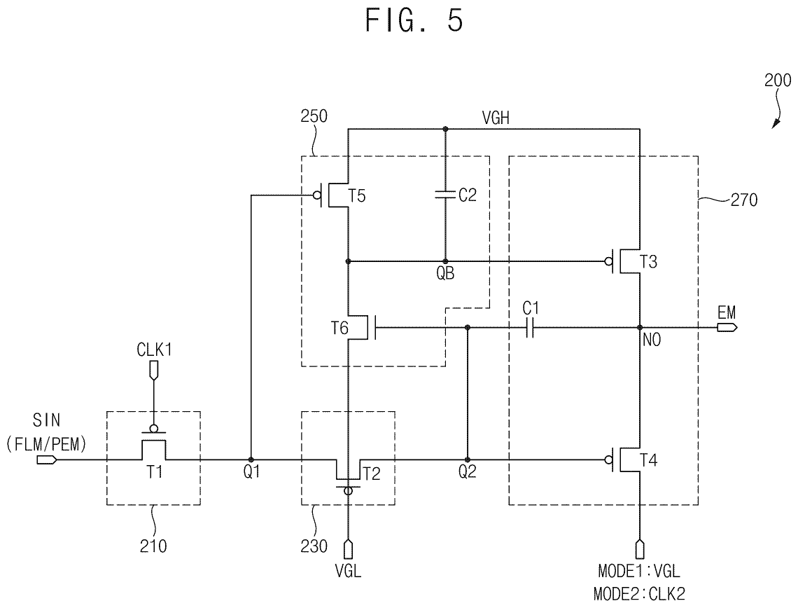

To output the emission signals EM1, EM2, EM3, EM4, etc., having the low period LP1 longer than or equal to two horizontal time periods 2H in the first mode MODE1 and to output the emission signals EM1, EM2, EM3, EM4, etc., having the low period LP2 shorter than or equal to one horizontal time period 1H in the second mode MODE2, the odd-numbered stages STG1, STG3, etc., (or output circuits of the odd-numbered stages STG1, STG3, etc.), may receive a low gate voltage VGL having a relatively low voltage level (e.g., logical low level, also referred to as a first voltage level) in the first mode MODE1, and may receive the second clock signal CLK2 in the second mode MODE2. Further, the even-numbered stages STG2, STG4, etc., (or output circuits of the even-numbered stages STG2, STG4, etc.), may receive the low gate voltage VGL in the first mode MODE1, and may receive the first clock signal CLK1 in the second mode MODE2. Operations of each stage STG1, STG2, STG3, STG4, etc., in the first mode MODE1 and the second mode MODE2 are described below with reference to FIGS. 5 through 29.

FIG. 5 is a circuit diagram illustrating an embodiment of a stage of an emission driver.

Referring to FIG. 5, a stage 200 of an emission driver in embodiments may include an input circuit 210 that transfers an input signal SIN to a first node Q1, a node separation circuit 230 connected between the first node Q1 and a second node Q2, a node control circuit 250 that controls a voltage of a third node QB, and an output circuit 270 that outputs an emission signal EM.

The input circuit 210 may receive a first clock signal CLK1, and may transfer the input signal SIN to the first node Q1 in response to the first clock signal CLK1. In some embodiments, the input signal SIN may be a start signal FLM in a case where the stage 200 is the first stage of the emission driver, and may be an emission signal PEM of a previous stage in a case where the stage 200 is a stage subsequent to the first stage.

In some embodiments, the input circuit 210 may include a first transistor T1. In an embodiment, the first transistor T1 may include a gate which receives the first clock signal CLK1, a first terminal which receives the input signal SIN, and a second terminal connected to the first node Q1, for example.

The node separation circuit 230 may include a second transistor T2 that is connected between the first node Q1 and the second node Q2 and that includes a gate which receives a low gate voltage VGL. Since the second transistor T2 receives the low gate voltage VGL for turning on the second transistor T2 at its gate, the second transistor T2 may be also referred to as an always-on transistor (“AOT”). Further, the second transistor T2 may prevent a voltage of the second node Q2 from being transferred to the first node Q1 when the voltage of the second node Q2 is boosted. In some embodiments, the second transistor T2 may include a gate which receives the low gate voltage VGL, a first terminal connected to the first node Q1, and a second terminal connected to the second node Q2.

The node control circuit 250 may control the voltage of the third node QB based on a voltage of the first node Q1 (and/or the voltage of the second node Q2), a high gate voltage VGH having a relatively high voltage level (e.g., logical high level, also referred to as a second voltage level) and the low gate voltage VGL. In an embodiment, the node control circuit 250 may provide the high gate voltage VGH to the third node QB when the voltage of the first node Q1 has a low level, and may provide the low gate voltage VGL to the third node QB when the voltage of the second node Q2 has a high level, for example.

In some embodiments, the node control circuit 250 may include a fifth transistor T5, a sixth transistor T6 and a second capacitor C2. In an embodiment, the fifth transistor T5 may include a gate connected to the first node Q1, a first terminal which receives the high gate voltage VGH, and a second terminal connected to the third node QB, for example. The sixth transistor T6 may include a gate connected to the second node Q2, a first terminal connected to the third node QB, and a second terminal which receives the low gate voltage VGL. The second capacitor C2 may include a first electrode which receives the high gate voltage VGH, and a second electrode connected to the third node QB. In some embodiments, the fifth transistor T5 may be, but is not limited to, a P-type metal-oxide-semiconductor (“PMOS”) transistor, and the sixth transistor T6 may be, but is not limited to, an N-type metal-oxide-semiconductor (“NMOS”) transistor.

The output circuit 270 may receive the high gate voltage VGH, the voltage of the second node Q2 and the voltage of the third node QB, may further receive the low gate voltage VGL in the first mode MODE1, and may further receive a second clock signal CLK2 different from the first clock signal CLK1 provided to the input circuit 210 in the second mode MODE2. In some embodiments, the first mode MODE1 may be a high luminance mode in which a DBV is greater than or equal to a reference value, and the second mode MODE2 may be a low luminance mode in which the DBV is less than the reference value, but is not limited thereto. Further, in some embodiments, the second clock signal CLK2 may be delayed by half a clock period from the first clock signal CLK1. In an embodiment, the clock period of the first and second clock signals CLK1 and CLK2 may correspond to two horizontal time periods, and the second clock signal CLK2 may be delayed by one horizontal time period from the first clock signal CLK1, for example. Although FIG. 5 illustrates an embodiment in which the stage 200 is an odd-numbered stage, in a case where the stage 200 is an even-numbered stage, the input circuit 210 may receive the second clock signal CLK2 instead of the first clock signal CLK1, and the output circuit 270 may receive the first clock signal CLK1 instead of the second clock signal CLK2 in the second mode MODE2.

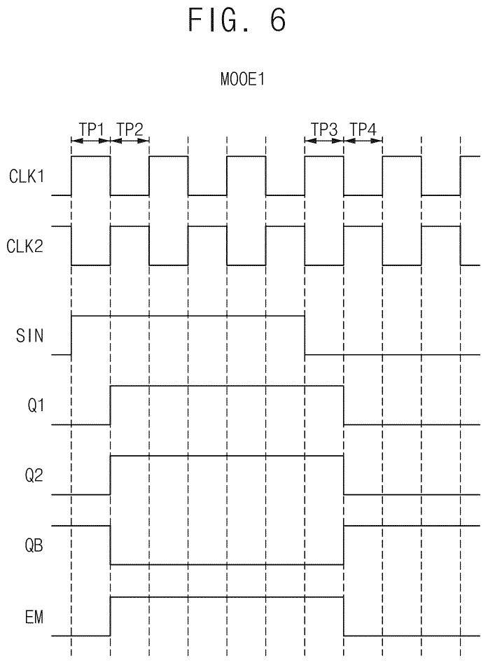

The output circuit 270 may output the high gate voltage VGH as the emission signal EM in response to the voltage of the third node QB, may output the low gate voltage VGL as the emission signal EM in response to the voltage of the second node Q2 in the first mode MODE1, and may output the second clock signal CLK2 as the emission signal EM in response to the voltage of the second node Q2 in the second mode MODE2. In an embodiment, the output circuit 270 may output the high gate voltage VGH as the emission signal EM when the voltage of the third node QB has a low level, may output the low gate voltage VGL as the emission signal EM when the voltage of the second node Q2 has the low level in the first mode MODE1, and may output the second clock signal CLK2 as the emission signal EM when the voltage of the second node Q2 has the low level in the second mode MODE2, for example. Accordingly, as described below with reference to FIGS. 6 through 14, the output circuit 270 may output the emission signal EM having a low period, in which the emission signal EM has a relatively low voltage level (or a first voltage level), longer than or equal to two horizontal time periods in the first mode MODE1, and may output the emission signal EM having a low period shorter than or equal to one horizontal time period in the second mode MODE2.

In some embodiments, the output circuit 270 may include a third transistor T3, a first capacitor C1 and a fourth transistor T4. In an embodiment, the third transistor T3 may include a gate connected to the third node QB, a first terminal which receives the high gate voltage VGH, and a second terminal connected to an output node NO from which the emission signal EM is output, for example. The first capacitor C1 may include a first electrode connected to the second node Q2, and a second electrode connected to the output node NO. The fourth transistor T4 may include a gate connected to the second node Q2, a first terminal connected to the output node NO, and a second terminal which receives the low gate voltage VGL in the first mode MODE1 and receives the second clock signal CLK2 in the second mode MODE2.

In some embodiments, a portion of the first through sixth transistors T1 through T6 of the stage 200 may be PMOS transistors, and the remainder of the first through sixth transistors T1 through T6 may be NMOS transistors. In an embodiment, as illustrated in FIG. 5, the first, second, third, fourth and fifth transistors T1, T2, T3, T4 and T5 may be PMOS transistors, and the sixth transistor T6 may be an NMOS transistor, for example, but is not limited thereto. In other embodiments, all of the first through sixth transistors T1 through T6 of the stage 200 may be PMOS transistors. In still other embodiments, all of the first through sixth transistors T1 through T6 of the stage 200 may be NMOS transistors.

Hereinafter, an embodiment of an operation of the stage 200 in the first mode MODE1 is described with reference to FIGS. 5 through 10.

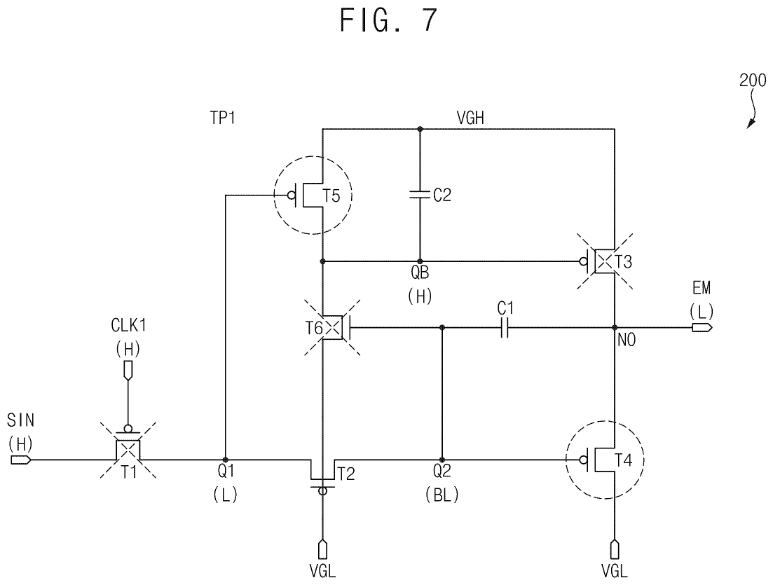

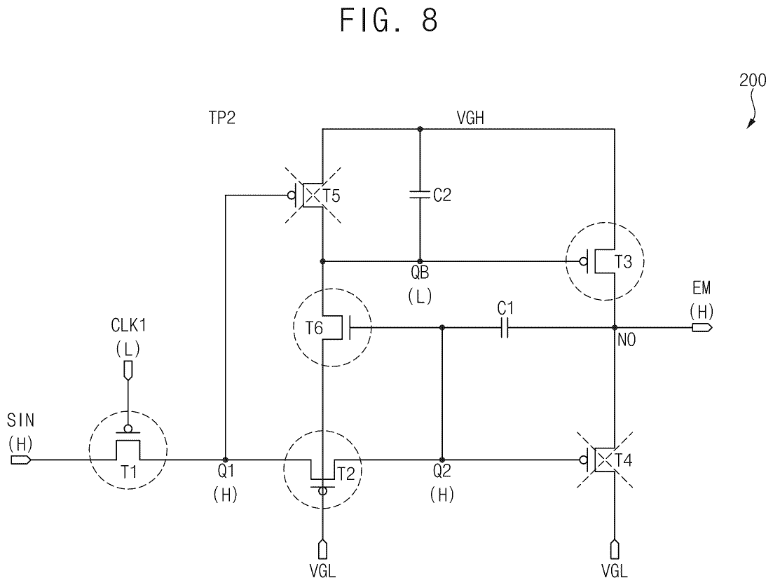

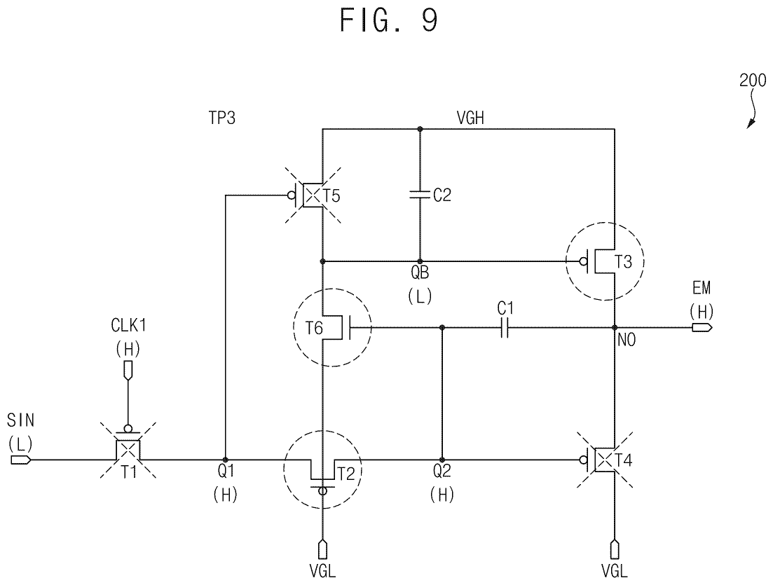

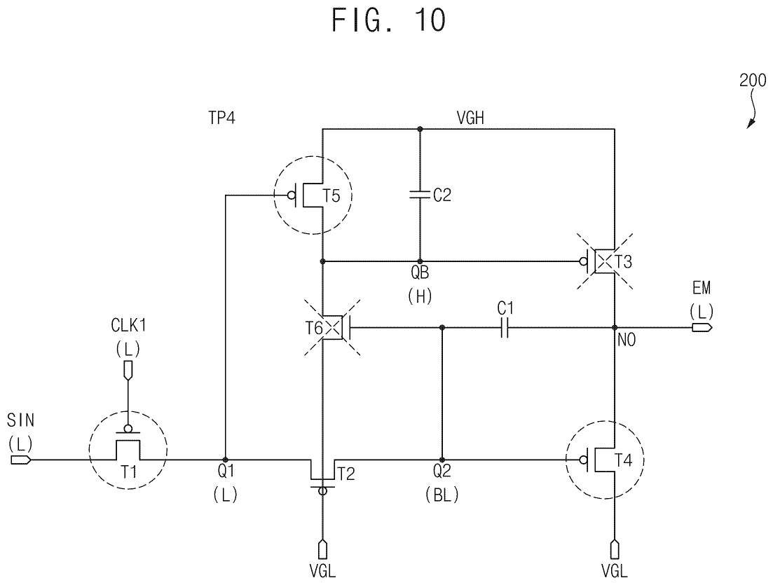

FIG. 6 is a timing diagram for describing an embodiment of an operation of a stage of FIG. 5 in a first mode, FIG. 7 is a circuit diagram for describing an embodiment of an operation of a stage of FIG. 5 in a first time period, FIG. 8 is a circuit diagram for describing an embodiment of an operation of a stage of FIG. 5 in a second time period, FIG. 9 is a circuit diagram for describing an embodiment of an operation of a stage of FIG. 5 in a third time period, and FIG. 10 is a circuit diagram for describing an embodiment of an operation of a stage of FIG. 5 in a fourth time period.

Referring to FIGS. 5 and 6, in the first mode MODE1, the stage 200 may receive the input signal SIN having a low period longer than or equal to two horizontal time periods, and may output the emission signal EM by delaying the input signal SIN by one horizontal time period. In some embodiments, the stage 200 may output the emission signal EM having a high level when the input signal SIN has the high level and the first clock signal CLK1 has the low level, and may output the emission signal EM having the low level when the input signal SIN has the low level and the first clock signal CLK1 has the low level.

In an embodiment, as illustrated in FIGS. 6 and 7, in a first time period TP1 in which the input signal SIN has the high level H and the first clock signal CLK1 has the high level H, the first transistor T1 may be turned off in response to the first clock signal CLK1 having the high level H, for example. Thus, the input signal SIN may not be transferred to the first node Q1, the voltage of the first node Q1 may have a low level L that is a previous level, and the voltage of the second node Q2 may have a boosted low level BL that is a previous level. The fifth transistor T5 may be turned on in response to the voltage of the first node Q1, and may transfer the high gate voltage VGH to the third node QB. Thus, the voltage of the third node QB may have the high level H. The third transistor T3 may be turned off in response to the voltage of the third node QB, and the sixth transistor T6 may be turned off in response to the voltage of the second node Q2. The fourth transistor T4 may be turned on in response to the voltage of the second node Q2, and may output the low gate voltage VGL as the emission signal EM. Accordingly, the emission signal EM having the low level L may be output at the output node NO.

As illustrated in FIGS. 6 and 8, in a second time period TP2 in which the input signal SIN has the high level H and the first clock signal CLK1 has the low level L, the first transistor T1 may be turned on in response to the first clock signal CLK1 having the low level L, and may transfer the input signal SIN to the first node Q1. Thus, the voltage of the first node Q1 may have the high level H. The fifth transistor T5 may be turned off in response to the voltage of the first node Q1. The second transistor T2 may be turned on in response to the low gate voltage VGL, and may transfer the voltage of the first node Q1 to the second node Q2. Thus, the voltage of the second node Q2 may have the high level H. The fourth transistor T4 may be turned off in response to the voltage of the second node Q2. The sixth transistor T6 may be turned on in response to the voltage of the second node Q2, and may transfer the low gate voltage VGL to the third node QB. Thus, the voltage of the third node QB may have the low level L. The third transistor T3 may be turned on in response to the voltage of the third node QB, and may output the high gate voltage VGH as the emission signal EM. Accordingly, the emission signal EM having the high level H may be output at the output node NO. Further, the stage 200 may output the emission signal EM having the high level H in a period between the second time period TP2 and a third time period TP3.

Thereafter, as illustrated in FIGS. 6 and 9, in the third time period TP3 in which the input signal SIN has the low level L and the first clock signal CLK1 has the high level H, the first transistor T1 may be turned off in response to the first clock signal CLK1 having the high level H. Thus, the input signal SIN may not be transferred to the first node Q1, the voltage of the first node Q1 may have the high level H that is a previous level, and the voltage of the second node Q2 may have the high level H that is a previous level. The fifth transistor T5 may be turned off in response to the voltage of the first node Q1, and the second transistor T2 may be turned on in response to the low gate voltage VGL. The fourth transistor T4 may be turned off in response to the voltage of the second node Q2. The sixth transistor T6 may be turned on in response to the voltage of the second node Q2, and may transfer the low gate voltage VGL to the third node QB. Thus, the voltage of the third node QB may have the low level L. The third transistor T3 may be turned on in response to the voltage of the third node QB, and may output the high gate voltage VGH as the emission signal EM. Accordingly, even when the input signal SIN is changed to the low level L, the stage 200 may output the emission signal EM having the high level H at the output node NO.

As illustrated in FIGS. 6 and 10, in a fourth time period TP4 in which the input signal SIN has the low level L and the first clock signal CLK1 has the low level L, the first transistor T1 may be turned on in response to the first clock signal CLK1 having the low level L, and may transfer the input signal SIN to the first node Q1. Thus, the voltage of the first node Q1 may have the low level L. The fifth transistor T5 may be turned on in response to the voltage of the first node Q1, and may transfer the high gate voltage VGH to the third node QB. Thus, the voltage of the third node QB may have the high level H. The third transistor T3 may be turned off in response to the voltage of the third node QB.

Further, in the fourth time period TP4, the second transistor T2 may be turned on in response to the low gate voltage VGL, and may transfer the voltage of the first node Q1 to the second node Q2. Thus, the voltage of the second node Q2 may have the low level L. The fourth transistor T4 may be turned on in response to the voltage of the second node Q2, and may transfer the low gate voltage VGL to the output node NO. Thus, a voltage of the output node NO connected to the second electrode of the first capacitor C1 may be changed from the high level H to the low level L. Further, when the voltage of the output node NO, or a voltage of the second electrode of the first capacitor C1 is decreased from the high level H to the low level L, by the coupling of the first capacitor C1, a voltage of the first electrode of the first capacitor C1, or the voltage of the second node Q2 also may be decreased from the low level L to the boosted low level BL. The boosted low level BL may be lower than a voltage level of the low gate voltage VGL applied to the gate of the second transistor T2, and thus the second transistor T2 may prevent the voltage of the second node Q2 having the boosted low level BL from being transferred to the first node Q1. Further, the fourth transistor T4 may be fully or completely turned on in response to the voltage of the second node Q2 having the boosted low level BL, and may output the emission signal EM having the low level L substantially the same as the voltage level of the low gate voltage VGL.

The stage 200 may continuously output the emission signal EM having the low level L in a period after the fourth time period TP4 until the input signal SIN is changed to the high level H and the first clock signal CLK1 becomes the low level L in the next frame period. Accordingly, the stage 200 may output the emission signal EM having the low period longer than or equal to two horizontal time periods in the first mode MODE1.

Hereinafter, an embodiment of an operation of the stage 200 in the second mode MODE2 is described with reference to FIG. 5 and FIGS. 11 through 14.

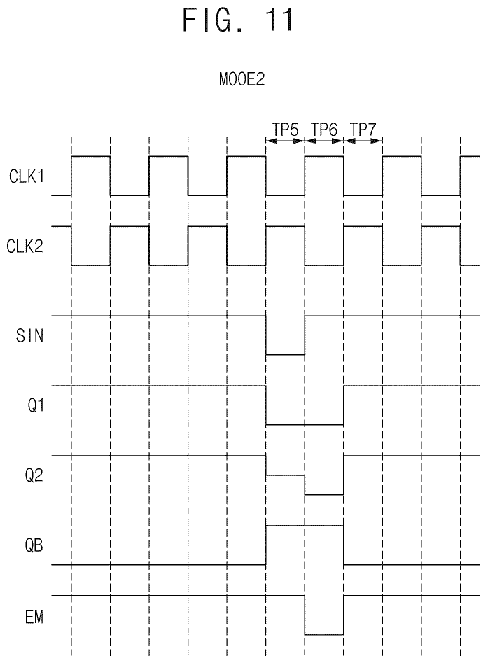

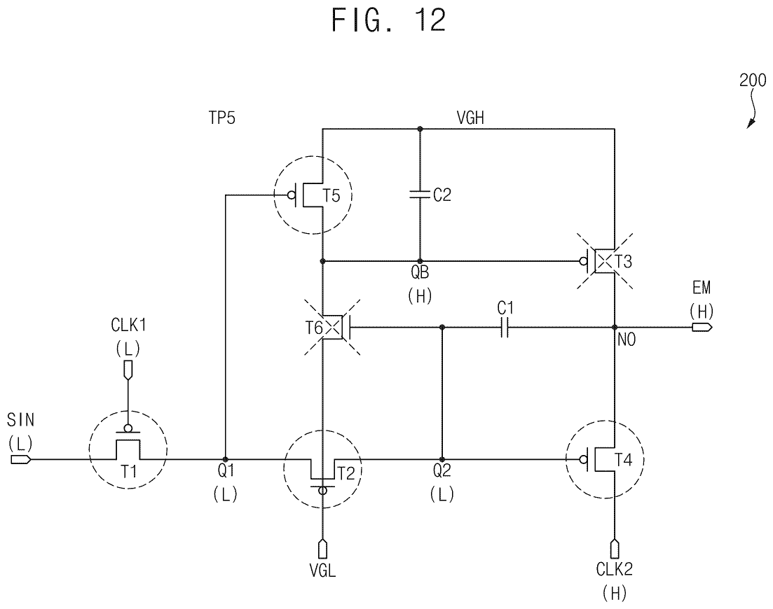

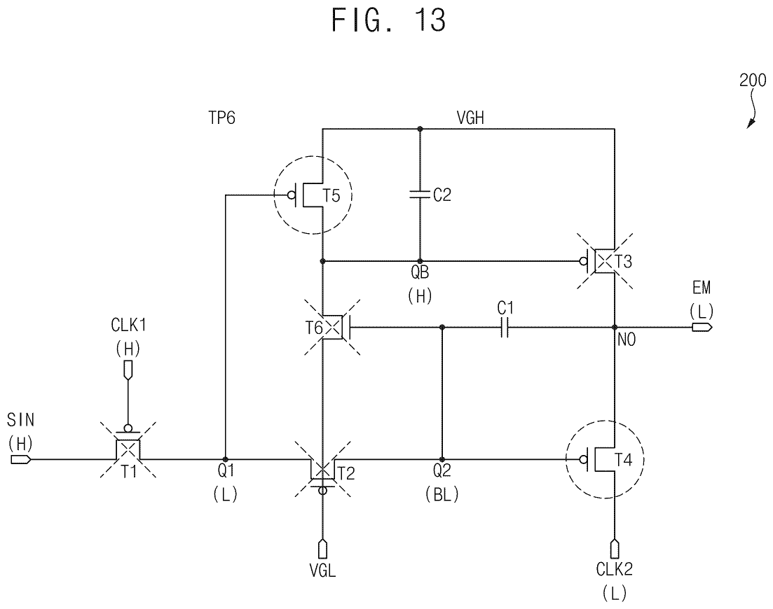

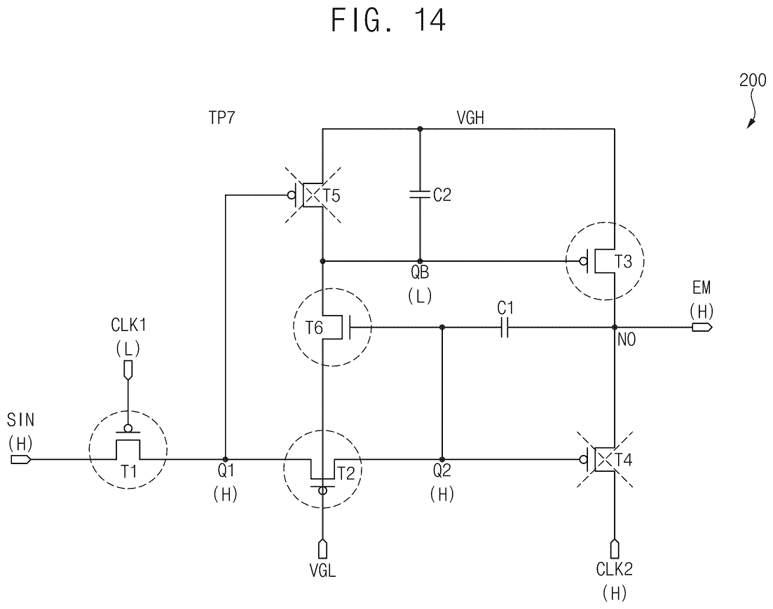

FIG. 11 is a timing diagram for describing an embodiment of an operation of a stage of FIG. 5 in a second mode, FIG. 12 is a circuit diagram for describing an embodiment of an operation of a stage of FIG. 5 in a fifth time period, FIG. 13 is a circuit diagram for describing an embodiment of an operation of a stage of FIG. 5 in a sixth time period, and FIG. 14 is a circuit diagram for describing an embodiment of an operation of a stage of FIG. 5 in a seventh time period.

Referring to FIGS. 5 and 11, in the second mode MODE2, the stage 200 may receive the input signal SIN having a low period shorter than or equal to one horizontal time period, and may output the emission signal EM by delaying the input signal SIN by one horizontal time period. In some embodiments, the stage 200 may receive the input signal SIN when the input signal SIN has a low level and the first clock signal CLK1 has a low level, and may output the emission signal EM having the low level when the second clock signal CLK2 has the low level after the input signal SIN is received.

In an embodiment, as illustrated in FIGS. 11 and 12, in a fifth time period TP5 in which the input signal SIN has the low level L and the first clock signal CLK1 has the low level L, the first transistor T1 may be turned on in response to the first clock signal CLK1 having the low level L, and may transfer the input signal SIN to the first node Q1, for example. Thus, the voltage of the first node Q1 may have the low level L. The fifth transistor T5 may be turned on in response to the voltage of the first node Q1, and may transfer the high gate voltage VGH to the third node QB. Thus, the voltage of the third node QB may have a high level H. The third transistor T3 may be turned off in response to the voltage of the third node QB. Further, the second transistor T2 may be turned on in response to the low gate voltage VGL, and may transfer the voltage of the first node Q1 to the second node Q2. Thus, the voltage of the second node Q2 may have the low level L. The sixth transistor T6 may be turned off in response to the voltage of the second node Q2. Although the fourth transistor T4 receives the low gate voltage VGL in the first mode MODE1, the fourth transistor T4 may receive the second clock signal CLK2 in the second mode MODE2. Further, the fourth transistor T4 may be turned on in response to the voltage of the second node Q2, and may output the second clock signal CLK2 having the high level H as the emission signal EM. Accordingly, in the fifth time period TP5, even when the input signal SIN has the low level L, the stage 200 may output the emission signal EM having the high level H at the output node NO.

As illustrated in FIGS. 11 and 13, in a sixth time period TP6 in which the input signal SIN has the high level H and the first clock signal CLK1 has the high level H, the first transistor T1 may be turned off in response to the first clock signal CLK1 having the high level H. Thus, the input signal SIN may not be transferred to the first node Q1, and the voltage of the first node Q1 may have the low level L that is a previous level. The fifth transistor T5 may be turned on in response to the voltage of the first node Q1, the voltage of the third node QB may have the high level H, and the third transistor T3 may be turned off in response to the voltage of the third node QB.

Further, in the sixth time period TP6, the second clock signal CLK2 may be decreased from the high level H to the low level L, and thus the voltage of the output node NO from which the second clock signal CLK2 is output may be decreased from the high level H to the low level L. Further, when the voltage of the output node NO, or the voltage of the second electrode of the first capacitor C1 is decreased from the high level H to the low level L, by the coupling of the first capacitor C1, the voltage of the first electrode of the first capacitor C1, or the voltage of the second node Q2 also may be decreased from the low level L to the boosted low level BL. The boosted low level BL may be lower than the voltage level of the low gate voltage VGL applied to the gate of the second transistor T2, and thus the second transistor T2 may prevent the voltage of the second node Q2 having the boosted low level BL from being transferred to the first node Q1. Further, the fourth transistor T4 may be fully turned on in response to the voltage of the second node Q2 having the boosted low level BL, and may output the emission signal EM having the low level L substantially the same as the voltage level (or the low level L) of the second clock signal CLK2. Accordingly, in the sixth time period TP6, even when the input signal SIN has the high level H, the stage 200 may output the emission signal EM having the low level L at the output node NO.

As illustrated in FIGS. 11 and 14, in a seventh time period TP7 in which the input signal SIN has the high level H and the first clock signal CLK1 has the low level L, the first transistor T1 may be turned on in response to the first clock signal CLK1 having the low level L, and may transfer the input signal SIN to the first node Q1. Thus, the voltage of the first node Q1 may have the high level H. The fifth transistor T5 may be turned off in response to the voltage of the first node Q1. The second transistor T2 may be turned on in response to the low gate voltage VGL, and may transfer the voltage of the first node Q1 to the second node Q2. Thus, the voltage of the second node Q2 may have the high level H. The fourth transistor T4 may be turned off in response to the voltage of the second node Q2. The sixth transistor T6 may be turned on in response to the voltage of the second node Q2, and may transfer the low gate voltage VGL to the third node QB. Thus, the voltage of the third node QB may have the low level L. The third transistor T3 may be turned on in response to the voltage of the third node QB, and may output the high gate voltage VGH as the emission signal EM. Accordingly, in the seventh time period TP7, the stage 200 may output the emission signal EM having the high level H at the output node NO.

The stage 200 may continuously output the emission signal EM having the high level H in a period after the seventh time period TP7 until the input signal SIN is changed to the low level L, and the first clock signal CLK1 and the second clock signal CLK2 sequentially become the low level L in the next frame period. Accordingly, the stage 200 may output the emission signal EM having the low period shorter than or equal to one horizontal time period in the second mode MODE2.

In a conventional emission driver, each stage may output an emission signal having a low period longer than or equal to two horizontal time periods. However, in the emission driver in embodiments, the stage 200 may not only output the emission signal EM having the low period longer than or equal to two horizontal time periods in the first mode MODE1, but also output the emission signal EM having the low period shorter than or equal to one horizontal time period in the second mode MODE2. That is, the emission driver in embodiments may normally operate not only in the first mode MODE1 (e.g., the high luminance mode) in which the low period of the emission signal EM is loner than or equal to two horizontal time periods, but also in the second mode MODE2 (e.g., the low luminance mode) in which the low period of the emission signal EM is shorter than one horizontal time period.

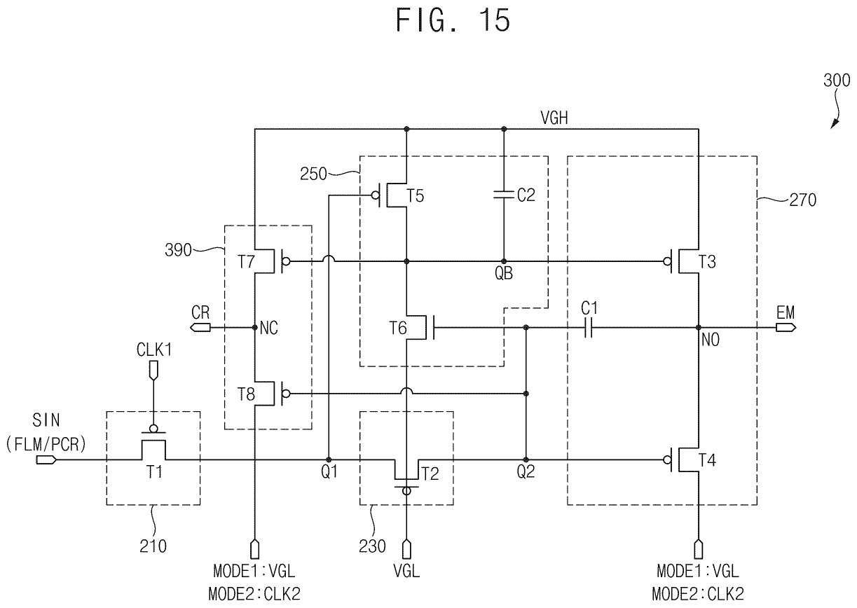

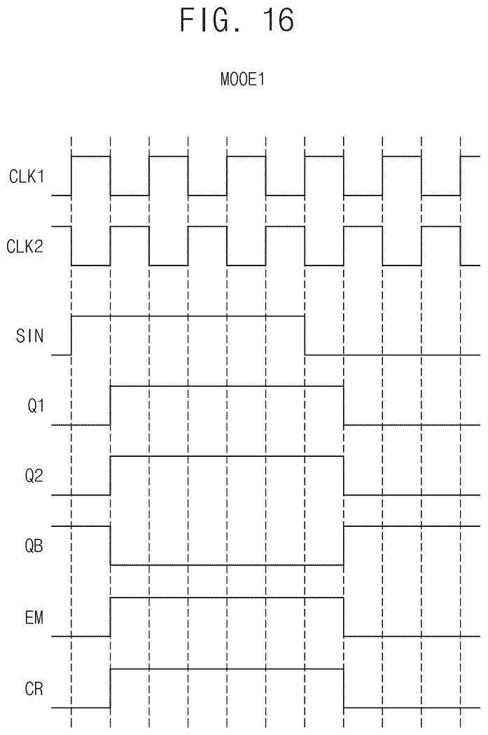

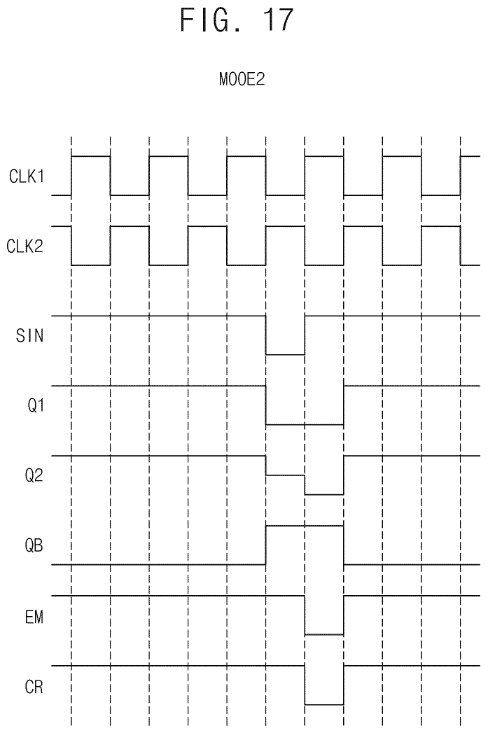

FIG. 15 is a circuit diagram illustrating an embodiment of a stage of an emission driver, FIG. 16 is a timing diagram for describing an embodiment of an operation of a stage of FIG. 15 in a first mode, and FIG. 17 is a timing diagram for describing an embodiment of an operation of a stage of FIG. 15 in a second mode.

Referring to FIG. 15, a stage 300 of an emission driver in embodiments may include an input circuit 210, a node separation circuit 230, a node control circuit 250, an output circuit 270, and a carry circuit 390 that outputs a carry signal CR. The stage 300 of FIG. 15 may have substantially the same configuration and substantially the same operation as a stage 200 of FIG. 5, except that the stage 300 may further include the carry circuit 390, and may receive, as an input signal SIN, a carry signal PCR of a previous stage instead of an emission signal of the previous stage.

The carry circuit 390 may receive a high gate voltage VGH, a voltage of a second node Q2 and a voltage of a third node QB, may further receive a low gate voltage VGL in a first mode MODE1, and may further receive a second clock signal CLK2 different from a first clock signal CLK1 provided to the input circuit 210 in a second mode MODE2. The carry circuit 390 may output the high gate voltage VGH as the carry signal CR in response to the voltage of the third node QB, may output the low gate voltage VGL as the carry signal CR in response to the voltage of the second node Q2 in the first mode MODE1, and may output the second clock signal CLK2 as the carry signal CR in response to the voltage of the second node Q2 in the second mode MODE2.

In some embodiments, the carry circuit 390 may include a seventh transistor T7 and an eighth transistor T8. In an embodiment, the seventh transistor T7 may include a gate connected to the third node QB, a first terminal which receives the high gate voltage VGH, and a second terminal connected to a carry node NC from which the carry signal CR is output, for example. The eighth transistor T8 may include a gate connected to the second node Q2, a first terminal connected to the carry node NC, and a second terminal which receives the low gate voltage VGL in the first mode MODE1 and receives the second clock signal CLK2 in the second mode MODE2.

In the first mode MODE1, as illustrated in FIG. 16, the stage 300 may receive the input signal SIN having a low period longer than or equal to two horizontal time periods, and may output an emission signal EM having a low period longer than or equal to two horizontal time periods and the carry signal CR having a low period longer than or equal to two horizontal time periods by delaying the input signal SIN by one horizontal time period. The emission signal EM output from the stage 300 may be provided to pixels of a display panel, and the carry signal CR output from the stage 300 may be provided to a next stage as an input signal SIN for the next stage.

Further, in the second mode MODE2, as illustrated in FIG. 17, the stage 300 may receive the input signal SIN having a low period shorter than or equal to one horizontal time period, and may output the emission signal EM having a low period shorter than or equal to one horizontal time period and the carry signal CR having a low period shorter than or equal to one horizontal time period by delaying the input signal SIN by one horizontal time period. Accordingly, the emission driver including the stage 300 may normally operate not only in the first mode MODE1 (e.g., the high luminance mode) in which the low period of the emission signal EM is loner than or equal to two horizontal time periods, but also in the second mode MODE2 (e.g., the low luminance mode) in which the low period of the emission signal EM is shorter than one horizontal time period.

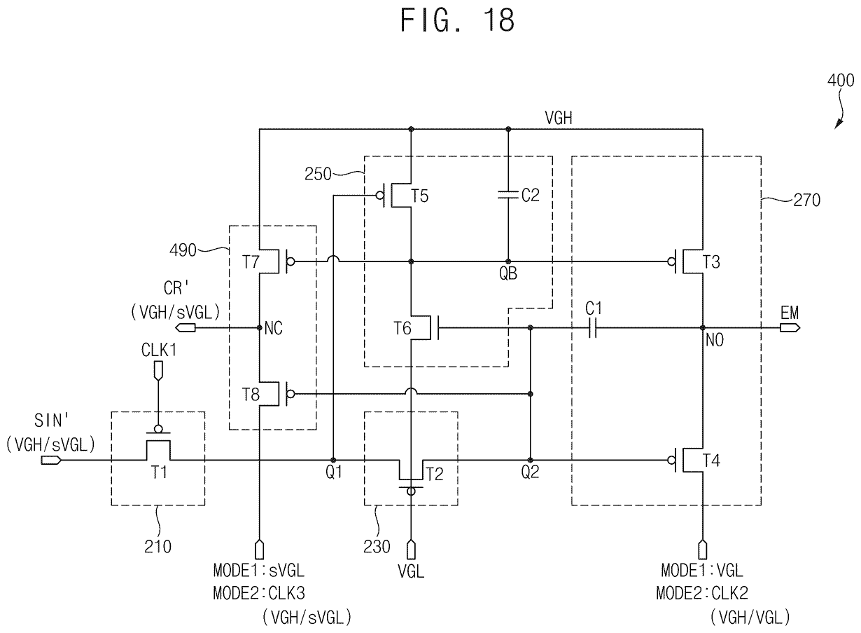

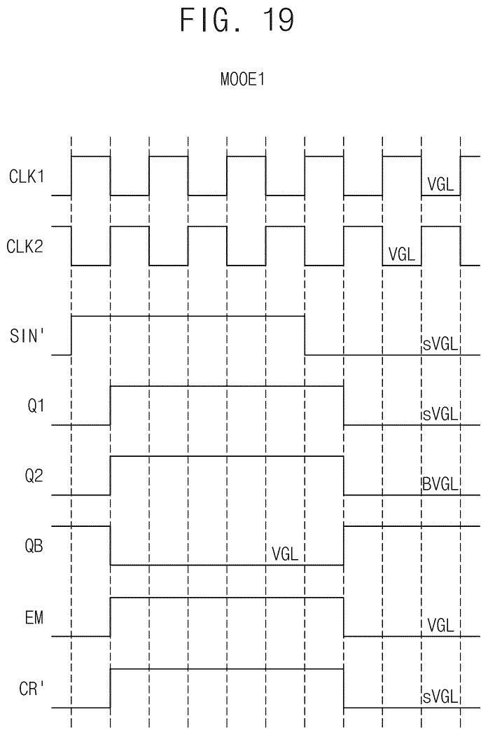

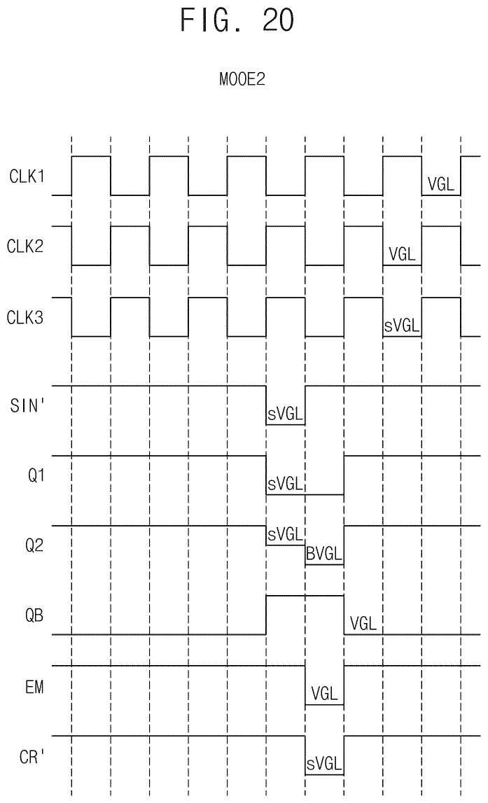

FIG. 18 is a circuit diagram illustrating an embodiment of a stage of an emission driver, FIG. 19 is a timing diagram for describing an embodiment of an operation of a stage of FIG. 18 in a first mode, and FIG. 20 is a timing diagram for describing an embodiment of an operation of a stage of FIG. 18 in a second mode.

Referring to FIG. 18, a stage 400 of an emission driver in embodiments may include an input circuit 210, a node separation circuit 230, a node control circuit 250, an output circuit 270, and a carry circuit 490 that outputs a carry signal CR′. The stage 400 of FIG. 15 may have substantially the same configuration and substantially the same operation as a stage 300 of FIG. 15, except that the carry circuit 490 may receive a small low gate voltage sVGL in a first mode MODE1 and may receive a third clock signal CLK3 in a second mode MODE2, and that low voltages of the carry signal CR′ and an input signal SIN′ are the small low gate voltage sVGL.

In the first mode MODE1, the carry circuit 490 may receive the small low gate voltage sVGL having an absolute value less than an absolute value of a low gate voltage VGL, and may output the small low gate voltage sVGL as the carry signal CR′ having a low level. Further, the carry signal CR′ having the small low gate voltage sVGL may be provided to a next stage as an input signal SIN′ for the next stage. Thus, a voltage difference between a high voltage and a low voltage of the input signal SIN′ and a voltage difference between a high voltage and a low voltage of an internal node (e.g., a first node Q1) of the stage 400 may be reduced, and a power consumption of the stage 400 and the emission driver may be reduced.

In an embodiment, in the first mode MODE1, as illustrated in FIG. 19, a first clock signal CLK1, a second clock signal CLK2, a third node QB and an emission signal EM may have the low gate voltage VGL as low voltages, and a second node Q2 may have a boosted low gate voltage BVGL as a low voltage, for example. However, the input signal SIN′, the carry signal CR′ and the first node Q1 may have the small low gate voltage sVGL having an absolute value less than an absolute value of the low gate voltage VGL as low voltages. Accordingly, the power consumption of the stage 400 and the emission driver may be reduced. Further, the stage 400 may receive the input signal SIN′ having a low period longer than or equal to two horizontal time periods, and may output the emission signal EM having a low period longer than or equal to two horizontal time periods and the carry signal CR′ having a low period longer than or equal to two horizontal time periods by delaying the input signal SIN′ by one horizontal time period.

In the second mode MODE2, the carry circuit 490 may receive the third clock signal CLK3 having a phase substantially equal to a phase of the second clock signal CLK2 and having the small low gate voltage sVGL as a low voltage, and may output the small low gate voltage sVGL as the carry signal CR′ having a low level. Thus, in the second mode MODE2, the emission signal EM and the carry signal CR′ may have substantially the same phase, but a voltage difference between a high voltage and a low voltage of the carry signal CR′ may be reduced compared with a voltage difference between a high voltage and a low voltage of the emission signal EM, thereby reducing the power consumption of the stage 400 and the emission driver.

In an embodiment, in the second mode MODE2, as illustrated in FIG. 20, the first clock signal CLK1, the second clock signal CLK2, the third node QB and the emission signal EM may have the low gate voltage VGL as low voltages, the second node Q2 may sequentially have the small low gate voltage sVGL and the boosted low gate voltage BVGL as a low voltage, and the third clock signal CLK3, the input signal SIN′, the carry signal CR′ and the first node Q1 may have the small low gate voltage sVGL having the absolute value less than the absolute value of the low gate voltage VGL as low voltages, for example. Accordingly, the power consumption of the stage 400 and the emission driver may be reduced. Further, the stage 400 may receive the input signal SIN′ having a low period shorter than or equal to one horizontal time period, and may output the emission signal EM having a low period shorter than or equal to one horizontal time period and the carry signal CR′ having a low period shorter than or equal to one horizontal time period by delaying the input signal SIN′ by one horizontal time period. Accordingly, the emission driver including the stage 400 may normally operate not only in the first mode MODE1 (e.g., a high luminance mode) in which the low period of the emission signal EM is loner than or equal to two horizontal time periods, but also in the second mode MODE2 (e.g., a low luminance mode) in which the low period of the emission signal EM is shorter than one horizontal time period.

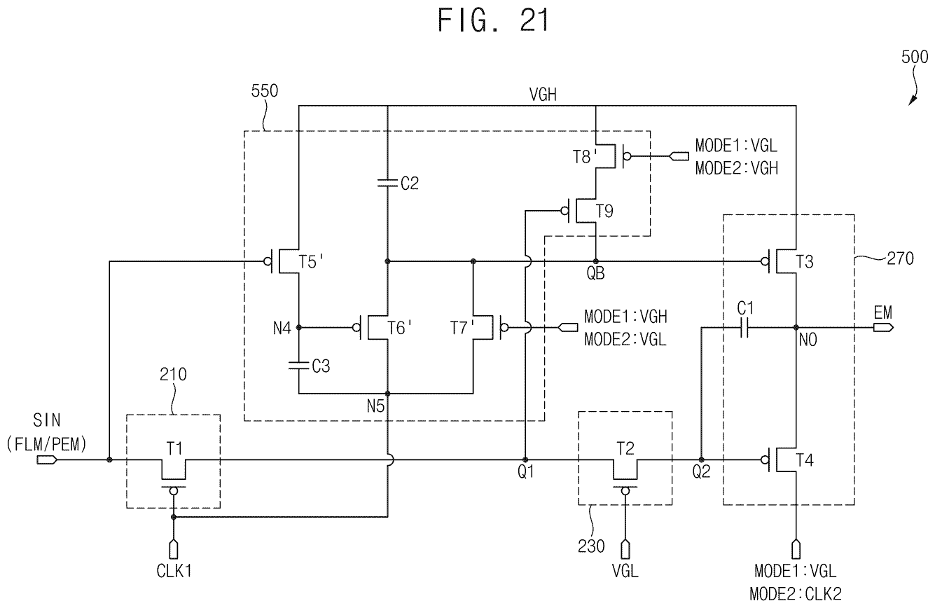

FIG. 21 is a circuit diagram illustrating an embodiment of a stage of an emission driver.

Referring to FIG. 21, a stage 500 of an emission driver in embodiments may include an input circuit 210, a node separation circuit 230, a node control circuit 550 and an output circuit 270. A configuration of the node control circuit 550 of the stage 500 may be different from a node control circuit 250 of a stage 200 of FIG. 5. Further, unlike the stage 200 of FIG. 5 in which a sixth transistor T6 is an NMOS transistor, all of first through ninth transistors T1, T2, T3, T4, T5′, T6′, T7′, T8′ and T9 included in the stage 500 may be PMOS transistors.

The node control circuit 550 may include a fifth transistor T5′, a sixth transistor T6′, a seventh transistor T7′, an eighth transistor T8′, a ninth transistor T9, a second capacitor C2 and a third capacitor C3. In a first mode MODE1, the seventh transistor T7′ may be turned off, the eighth transistor T8′ may be turned on, and the node control circuit 550 may control a voltage of a third node QB by applying a first clock signal CLK1 to the third node QB through the sixth transistor T6′ or by applying a high gate voltage VGH to the third node QB through the eighth and ninth transistors T8′ and T9. Further, in a second mode MODE2, the seventh transistor T7′ may be turned on, the eighth transistor T8′ may be turned off, and the node control circuit 550 may control the voltage of the third node QB by applying the first clock signal CLK1 to the third node QB through the seventh transistor T7′ (and/or the sixth transistor T6′).

The fifth transistor T5′ may apply the high gate voltage VGH to a fourth node N4 in response to an input signal SIN. The sixth transistor T6′ may apply the first clock signal CLK1 to the third node QB in response to a voltage of the fourth node N4. The third capacitor C3 may be connected between the fourth node N4 and a line which transfers the first clock signal CLK1. The seventh transistor T7′ may receive the high gate voltage VGH in the first mode MODE1, and may receive a low gate voltage VGL in the second mode MODE2. The eighth transistor T8′ may receive the low gate voltage VGL in the first mode MODE1, and may receive the high gate voltage VGH in the second mode MODE2. The ninth transistor T9 may be connected in series with the eighth transistor T8′ between a line which transfers the high gate voltage VGH and the third node QB, and may apply the high gate voltage VGH to the third node QB in response to a voltage of a first node Q1 in the first mode MODE1. The second capacitor C2 may be connected between the line which transfers the high gate voltage VGH and the third node QB.

In some embodiments, the fifth transistor T5′ may include a gate which receives the input signal SIN, a first terminal which receives the high gate voltage VGH, and a second terminal connected to the fourth node N4. The sixth transistor T6′ may include a gate connected to the fourth node N4, a first terminal connected to the third node QB, and a second terminal connected to a fifth node N5 and receiving the first clock signal CLK1. The seventh transistor T7′ may include a gate which receives the high gate voltage VGH in the first mode MODE1 and receives the low gate voltage VGL in the second mode MODE2, a first terminal connected to the third node QB, and a second terminal connected to the fifth node N5 and receiving the first clock signal CLK1. The eighth transistor T8′ may include a gate which receives the low gate voltage VGL in the first mode MODE1 and the high gate voltage VGH in the second mode MODE2, a first terminal which receives the high gate voltage VGH, and a second terminal connected to the ninth transistor T9. The ninth transistor T9 may include a gate connected to the first node Q1, a first terminal connected to the second terminal of the eighth transistor T8′, and a second terminal connected to the third node QB. The second capacitor C2 may include a first electrode which receives the high gate voltage VGH, and a second electrode connected to the third node QB. The third capacitor C3 may include a first electrode connected to the fourth node N4, and a second electrode connected to the fifth node N5 and receiving the first clock signal CLK1.

Further, in some embodiments, as illustrated in FIG. 21, all of the first through ninth transistors T1, T2, T3, T4, T5′, T6′, T7′, T8′ and T9 included in the stage 500 may be PMOS transistors. In other embodiments, at least one of the first through ninth transistors T1, T2, T3, T4, T5′, T6′, T7′, T8′ and T9 may be an NMOS transistor.

Hereinafter, an embodiment of an operation of the stage 500 in the first mode MODE1 is described with reference to FIGS. 6 and 21 through 25.

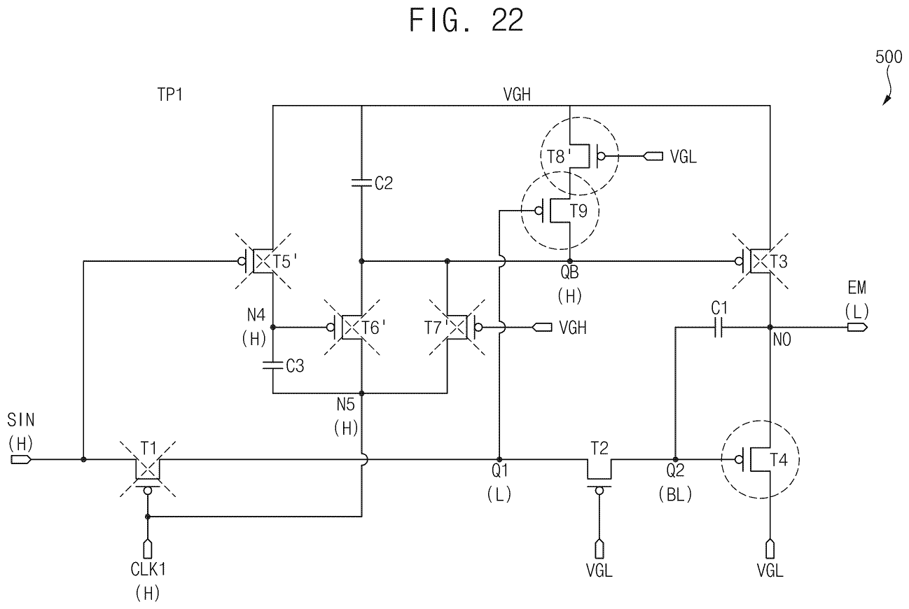

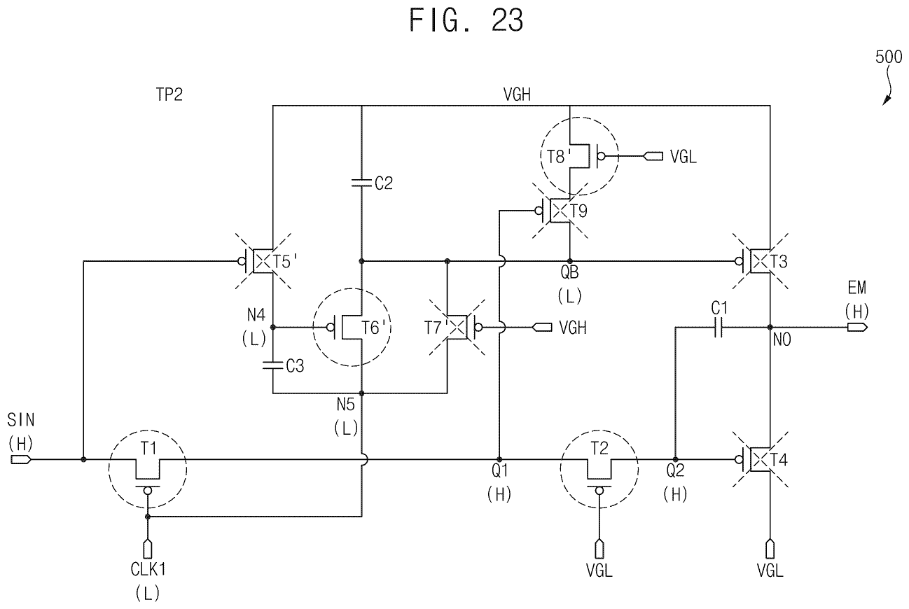

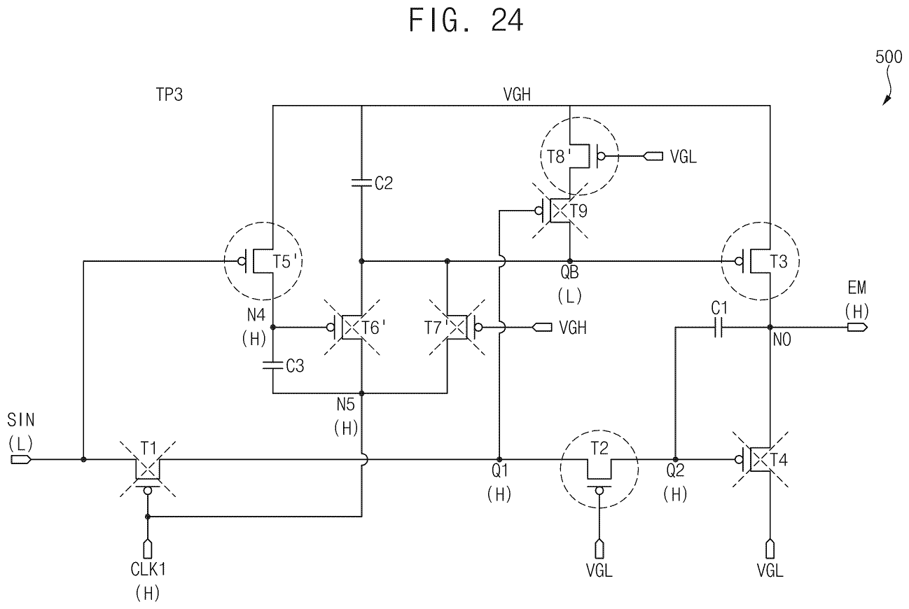

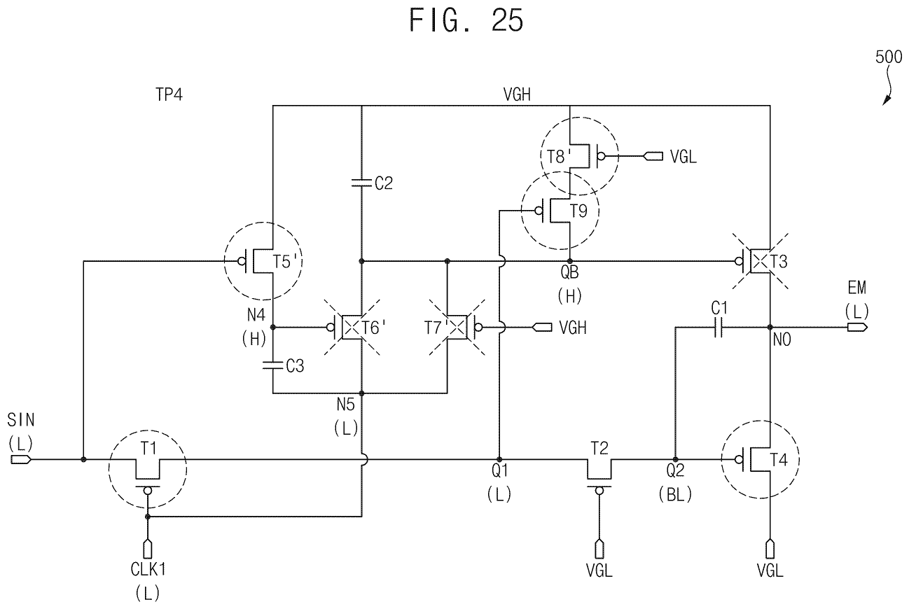

FIG. 22 is a circuit diagram for describing an embodiment of an operation of a stage of FIG. 21 in a first time period, FIG. 23 is a circuit diagram for describing an embodiment of an operation of a stage of FIG. 21 in a second time period, FIG. 24 is a circuit diagram for describing an embodiment of an operation of a stage of FIG. 21 in a third time period, and FIG. 25 is a circuit diagram for describing an embodiment of an operation of a stage of FIG. 21 in a fourth time period.

Referring to FIGS. 6 and 21, in the first mode MODE1, the stage 500 may receive the input signal SIN having a low period longer than or equal to two horizontal time periods, and may output an emission signal EM by delaying the input signal SIN by one horizontal time period.

In an embodiment, as illustrated in FIGS. 6 and 22, in a first time period TP1 in which the input signal SIN has a high level H and the first clock signal CLK1 has the high level H, the first transistor T1 may be turned off in response to the first clock signal CLK1 having the high level H, for example. Thus, the input signal SIN may not be transferred to the first node Q1, a voltage of the first node Q1 may have a low level L that is a previous level, and the voltage of the second node Q2 may have a boosted low level BL that is a previous level. Further, the fifth transistor T5′ may be turned off in response to the input signal SIN, and a voltage of the fourth node N4 may have the high level H that is a previous level. A voltage of the fifth node N5 may have the high level H based on the first clock signal CLK1. The sixth transistor T6′ may be turned off in response to the voltage of the fourth node N4, and the seventh transistor T7′ may be turned off in response to the high gate voltage VGH. The eighth transistor T8′ may be turned on in response to the low gate voltage VGL, the ninth transistor T9 may be turned on in response to the voltage of the first node Q1, and the eighth and ninth transistors T8′ and T9 may transfer the high gate voltage VGH to the third node QB. Thus, the voltage of the third node QB may have the high level H, and the third transistor T3 may be turned off in response to the voltage of the third node QB. The fourth transistor T4 may be turned on in response to the voltage of the second node Q2, and may output the low gate voltage VGL as the emission signal EM. Accordingly, the emission signal EM having the low level L may be output at the output node NO.

As illustrated in FIGS. 6 and 23, in a second time period TP2 in which the input signal SIN has the high level H and the first clock signal CLK1 has the low level L, the first transistor T1 may be turned on in response to the first clock signal CLK1 having the low level L, and may transfer the input signal SIN to the first node Q1. Thus, the voltage of the first node Q1 may have the high level H. The second transistor T2 may be turned on in response to the low gate voltage VGL, and may transfer the voltage of the first node Q1 to the second node Q2. Thus, the voltage of the second node Q2 may have the high level H. The fourth transistor T4 may be turned off in response to the voltage of the second node Q2. The fifth transistor T5′ may be turned off in response to the input signal SIN, and the seventh transistor T7′ may be turned off in response to the high gate voltage VGH. Further, the eighth transistor T8′ may be turned on in response to the low gate voltage VGL, and the ninth transistor T9 may be turned off in response to the voltage of the first node Q1. The voltage of the fifth node N5 to which the first clock signal CLK1 is applied may be decreased from the high level H to the low level L. When the voltage of the fifth node N5, or a voltage of the second electrode of the third capacitor C3 is decreased from the high level H to the low level L, by coupling of the third capacitor C3, a voltage of the first electrode of the third capacitor C3, or the voltage of the fourth node N4 also may be decreased from the high level H to the low level L. The sixth transistor T6′ may be turned on in response to the voltage of the fourth node N4, and may transfer the first clock signal CLK1 having the low level L to the third node QB. Thus, the voltage of the third node QB may have the low level L. The third transistor T3 may be turned on in response to the voltage of the third node QB, and may output the high gate voltage VGH as the emission signal EM. Accordingly, the emission signal EM having the high level H may be output at the output node NO. Further, the stage 500 may output the emission signal EM having the high level H in a period between the second time period TP2 and a third time period TP3.

Thereafter, as illustrated in FIGS. 6 and 24, in a third time period TP3 in which the input signal SIN has the low level L and the first clock signal CLK1 has the high level H, the first transistor T1 may be turned off in response to the first clock signal CLK1 having the high level H. Thus, the input signal SIN may not be transferred to the first node Q1, the voltage of the first node Q1 may have the high level H that is a previous level, the second transistor T2 may be turned on in response to the high gate voltage, and the voltage of the second node Q2 may have the high level H that is a previous level. The fourth transistor T4 may be turned off in response to the voltage of the second node Q2. The fifth transistor T5′ may be turned on in response to the input signal SIN, and may transfer the high gate voltage VGH to the fourth node N4. Thus, the voltage of the fourth node N4 may have the high level H. The voltage of the fifth node N5 may have the high level H based on the first clock signal CLK1. The sixth transistor T6′ may be turned off in response to the voltage of the fourth node N4, and the seventh transistor T7′ may be turned off in response to the high gate voltage VGH. Further, the eighth transistor T8′ may be turned on in response to the low gate voltage VGL, and the ninth transistor T9 may be turned off in response to the voltage of the first node Q1. Thus, the voltage of the third node QB may have the low level L that is a previous level. The third transistor T3 may be turned on in response to the voltage of the third node QB, and may output the high gate voltage VGH as the emission signal EM. Accordingly, even when the input signal SIN is changed to the low level L, the stage 500 may output the emission signal EM having the high level H at the output node NO.

As illustrated in FIGS. 6 and 25, in a fourth time period TP4 in which the input signal SIN has the low level L and the first clock signal CLK1 has the low level L, the first transistor T1 may be turned on in response to the first clock signal CLK1 having the low level L, and may transfer the input signal SIN to the first node Q1. Thus, the voltage of the first node Q1 may have the low level L. The fifth transistor T5′ may be turned on in response to the input signal SIN, and may transfer the high gate voltage VGH to the fourth node N4. Thus, the voltage of the fourth node N4 may have the high level H. The voltage of the fifth node N5 may have the high level H based on the first clock signal CLK1. The sixth transistor T6′ may be turned off in response to the voltage of the fourth node N4, and the seventh transistor T7′ may be turned off in response to the high gate voltage VGH. The eighth transistor T8′ may be turned on in response to the low gate voltage VGL, the ninth transistor T9 may be turned on in response to the voltage of the first node Q1, and the eighth and ninth transistors T8′ and T9 may transfer the high gate voltage VGH to the third node QB. Thus, the voltage of the third node QB may have high level H, and the third transistor T3 may be turned off in response to the voltage of the third node QB. The second transistor T2 may be turned on in response to the low gate voltage VGL, and may transfer the voltage of the first node Q1 to the second node Q2. Thus, the voltage of the second node Q2 may have the low level L. The fourth transistor T4 may be turned on in response to the voltage of the second node Q2, and may transfer the low gate voltage VGL to the output node NO. Thus, the voltage of the output node NO connected to the second electrode of the first capacitor C1 may be changed from the high level H to the low level L. Further, when the voltage of the output node NO, or the voltage of the second electrode of the first capacitor C1 is decreased from the high level H to the low level L, by the coupling of the first capacitor C1, the voltage of the first electrode of the first capacitor C1, or the voltage of the second node Q2 also may be decreased from the low level L to a boosted low level BL. The boosted low level BL may lower than a voltage level of the low gate voltage VGL applied to the gate of the second transistor T2, and thus the second transistor T2 may prevent the voltage of the second node Q2 having the boosted low level BL from being transferred to the first node Q1. Further, the fourth transistor T4 may be fully or completely turned on in response to the voltage of the second node Q2 having the boosted low level BL, and may output the emission signal EM having the low level L substantially the same as the voltage level of the low gate voltage VGL.

The stage 500 may continuously output the emission signal EM having the low level L in a period after the fourth time period TP4 until the input signal SIN is changed to the high level H and the first clock signal CLK1 becomes the low level L in the next frame period. Accordingly, the stage 500 may output the emission signal EM having a low period longer than or equal to two horizontal time periods in the first mode MODE1.

Hereinafter, an embodiment of an operation of the stage 500 in the second mode MODE2 is described with reference to FIGS. 21 and 26 through 29.

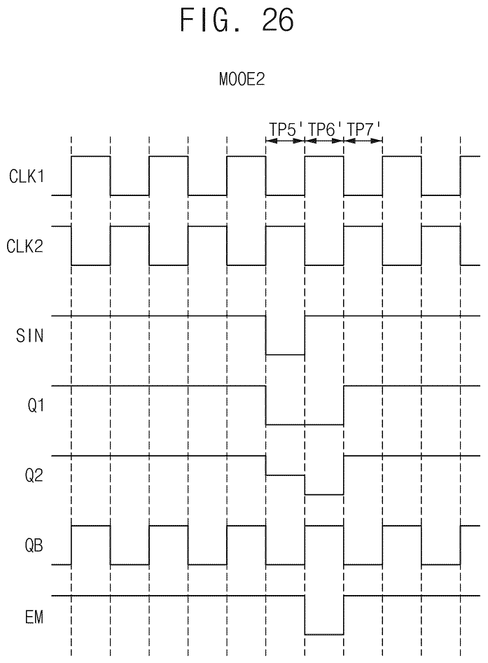

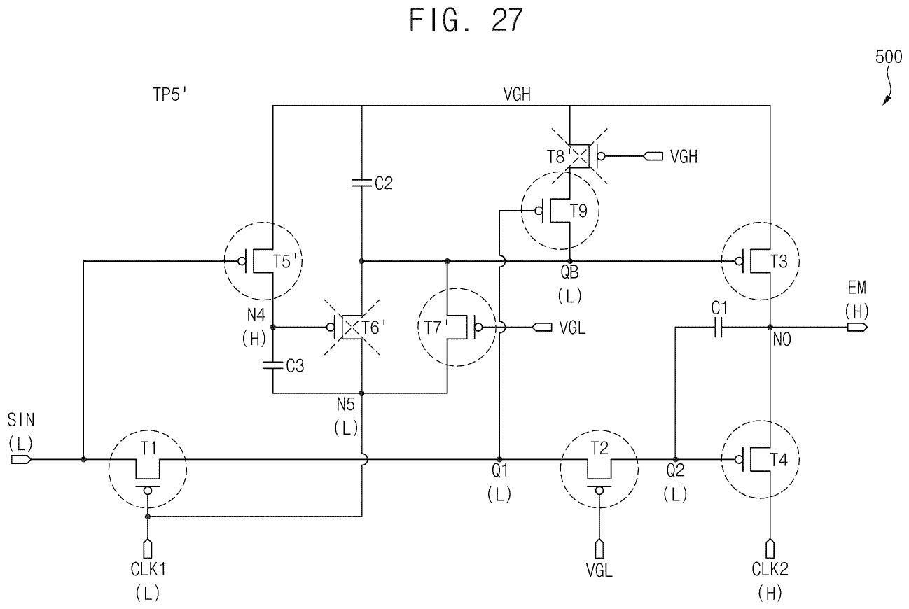

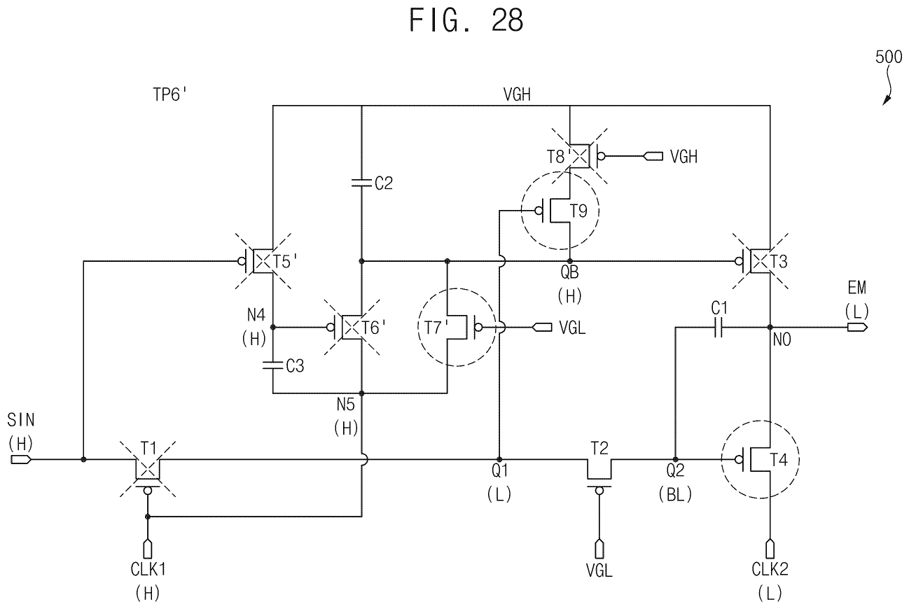

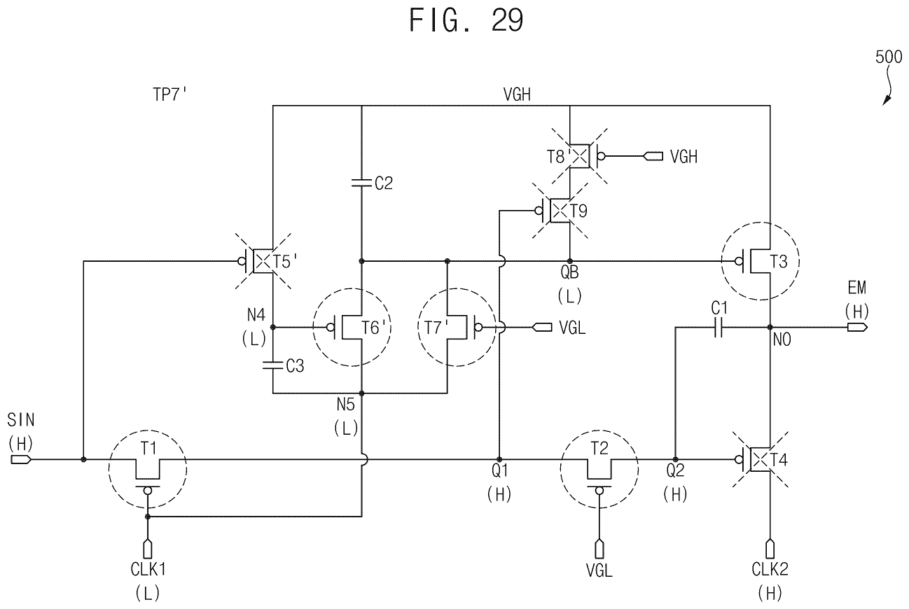

FIG. 26 is a timing diagram for describing an embodiment of an operation of a stage of FIG. 21 in a second mode, FIG. 27 is a circuit diagram for describing an embodiment of an operation of a stage of FIG. 21 in a fifth time period, FIG. 28 is a circuit diagram for describing an embodiment of an operation of a stage of FIG. 21 in a sixth time period, and FIG. 29 is a circuit diagram for describing an embodiment of an operation of a stage of FIG. 21 in a seventh time period.

Referring to FIGS. 21 and 26, in the second mode MODE2, the stage 500 may receive the input signal SIN having a low period shorter than or equal to one horizontal time period, and may output the emission signal EM by delaying the input signal SIN by one horizontal time period.

In an embodiment, as illustrated in FIGS. 26 and 27, in a fifth time period TP5′ in which the input signal SIN has the low level L and the first clock signal CLK1 has the low level L, the first transistor T1 may be turned on in response to the first clock signal CLK1 having the low level L, and may transfer the input signal SIN to the first node Q1, for example. Thus, the voltage of the first node Q1 may have the low level L. The fifth transistor T5′ may be turned on in response to the input signal SIN, and may transfer the high gate voltage VGH to the fourth node N4. Thus, the voltage of the fourth node N4 may have the high level H. The voltage of the fifth node N5 may have the low level L based on the first clock signal CLK1. The eighth transistor T8′ may be turned off in response to the high gate voltage VGH, and the ninth transistor T9 may be turned on in response to the voltage of the first node Q1. The seventh transistor T7′ may be turned on in response to the low gate voltage VGL, and may transfer the first clock signal CLK1 to the third node QB. Thus, the voltage of the third node QB may have the low level L. The third transistor T3 may be turned on in response to the third node QB, and may transfer the high gate voltage VGH to the output node NO. Further, the second transistor T2 may be turned on in response to the low gate voltage VGL, and may transfer the voltage of the first node Q1 to the second node Q2. Thus, the voltage of the second node Q2 may have the low level L. The fourth transistor T4 may be turned on in response to the voltage of the second node Q2, and may transfer the second clock signal CLK2 having the high level H to the output node NO. Accordingly, in the fifth time period TP5′, even when the input signal SIN has the low level L, the stage 500 may output the emission signal EM having the high level H at the output node NO by the third and fourth transistors T3 and T4.

As illustrated in FIGS. 26 and 28, in a sixth time period TP6′ in which the input signal SIN has the high level H and the first clock signal CLK1 has the high level H, the first transistor T1 may be turned off in response to the first clock signal CLK1 having the high level H. Thus, the input signal SIN may not be transferred to the first node Q1, and the voltage of the first node Q1 may have the low level L that is a previous level. Further, the fifth transistor T5′ may be turned off in response to the input signal SIN, the voltage of the fourth node N4 may have the high level H that is a previous level, and the sixth transistor T6′ may be turned off in response to the voltage of the fourth node N4. The voltage of the fifth node N5 may have the high level H based on the first clock signal CLK1. The eighth transistor T8′ may be turned off in response to the high gate voltage VGH, and the ninth transistor T9 may be turned on in response to the voltage of the first node Q1. The seventh transistor T7′ may be turned on in response to the low gate voltage VGL, and may transfer the first clock signal CLK1 to the third node QB. Thus, the voltage of the third node QB may have the high level H. The third transistor T3 may be turned off in response to the voltage of the third node QB. Further, in the sixth time period TP6′, the second clock signal CLK2 may be decreased from the high level H to the low level L, and thus the voltage of the output node NO from which the second clock signal CLK2 is output may be decreased from the high level H to the low level L. Further, when the voltage of the output node NO, or the voltage of the second electrode of the first capacitor C1 is decreased from the high level H to the low level L, by the coupling of the first capacitor C1, the voltage of the first electrode of the first capacitor C1, or the voltage of the second node Q2 also may be decreased from the low level L to the boosted low level BL. The boosted low level BL may be lower than the voltage level of the low gate voltage VGL applied to the gate of the second transistor T2, and thus the second transistor T2 may prevent the voltage of the second node Q2 having the boosted low level BL from being transferred to the first node Q1. Further, the fourth transistor T4 may be fully turned on in response to the voltage of the second node Q2 having the boosted low level BL, and may output the emission signal EM having the low level L substantially the same as the voltage level (or the low level L) of the second clock signal CLK2. Accordingly, in the sixth time period TP6′, even when the input signal SIN has the high level H, the stage 500 may output the emission signal EM having the low level L at the output node NO.

As illustrated in FIGS. 26 and 29, in a seventh time period TP7′ in which the input signal SIN has the high level H and the first clock signal CLK1 has the low level L, the first transistor T1 may be turned on in response to the first clock signal CLK1 having the low level L, and may transfer the input signal SIN to the first node Q1. Thus, the voltage of the first node Q1 may have the high level H. The second transistor T2 may be turned on in response to the low gate voltage VGL, and may transfer the voltage of the first node Q1 to the second node Q2. Thus, the voltage of the second node Q2 may have the high level H. The fourth transistor T4 may be turned off in response to the voltage of the second node Q2. The fifth transistor T5′ may be turned off in response to the input signal SIN, the eighth transistor T8′ may be turned off in response to the high gate voltage VGH, and the ninth transistor T9 may be turned off in response to the voltage of the first node Q1. The voltage of the fifth node N5 to which the first clock signal CLK1 is applied may be decreased from the high level H to the low level L. When the voltage of the fifth node N5, or the voltage of the second electrode of the third capacitor C3 is decreased from the high level H to the low level L, by the coupling of the third capacitor C3, the voltage of the first electrode of the third capacitor C3, or the voltage of the fourth node N4 also may be decreased from the high level H to the low level L. The sixth transistor T6′ may be turned on in response to the voltage of the fourth node N4, and the seventh transistor T7′ may be turned on in response to the low gate voltage VGL. Thus, the sixth and seventh transistors T6′ and T7′ may transfer the first clock signal CLK1 having the low level L to the third node QB, and the voltage of the third node QB may have the low level L. The third transistor T3 may be turned on in response to the voltage of the third node QB, and may output the high gate voltage VGH as the emission signal EM. Accordingly, in the seventh time period TP7′, the stage 500 may output the emission signal EM having the high level H at the output node NO.

The stage 500 may continuously output the emission signal EM having the high level H in a period after the seventh time period TP7 until the input signal SIN is changed to the low level L and the first clock signal CLK1 and the second clock signal CLK2 sequentially become the low level L in the next frame period. As illustrated in FIG. 26, even when the voltage of the third node QB periodically transitions between the high level H and the low level L and the third transistor T3 is periodically turned off, the emission signal EM may be maintained at the high level H until the fourth transistor T4 is turned on. Accordingly, the stage 500 may output the emission signal EM having a low period shorter than or equal to one horizontal time period in the second mode MODE2. That is, the emission driver in embodiments may normally operate not only in the first mode MODE1 (e.g., a high luminance mode) in which the low period of the emission signal EM is longer than or equal to two horizontal time periods, but also in the second mode MODE2 (e.g., a low luminance mode) in which the low period of the emission signal EM is shorter than one horizontal time period.

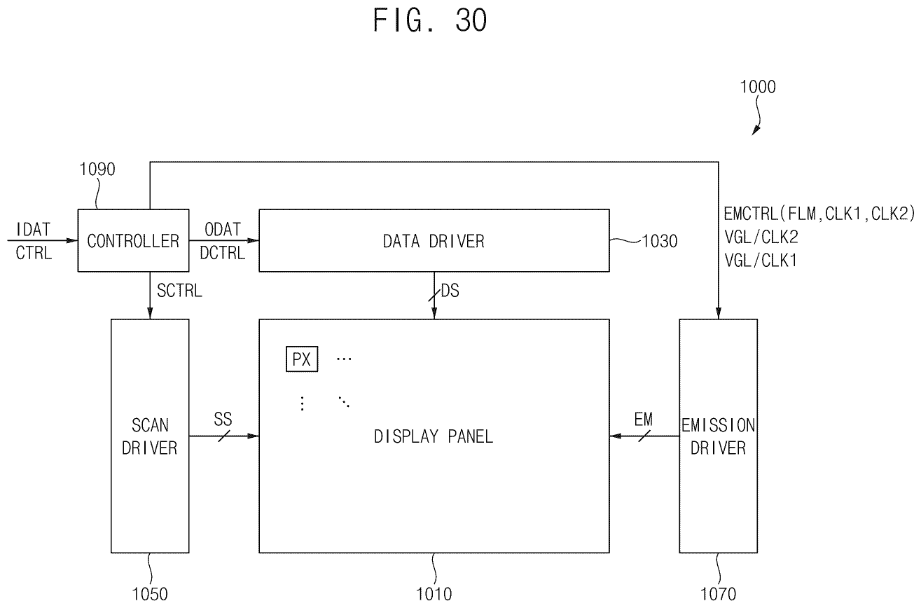

FIG. 30 is a block diagram illustrating an embodiment of a display device including an emission driver.

Referring to FIG. 30, a display device 1000 in embodiments may include a display panel 1010 that includes a plurality of pixels PX, a data driver 1030 that provides data signals DS to the plurality of pixels PX, a scan driver 1050 that provides scan signals SS to the plurality of pixels PX, an emission driver 1070 that provides emission signals EM to the plurality of pixels PX, and a controller 1090 that controls the data driver 1030, the scan driver 1050 and the emission driver 1070.

The display panel 1010 may include data lines, scan lines, emission lines, and the plurality of pixels PX connected to the data lines, the scan lines and the emission lines. Each pixel PX may emit light in response to the emission signal EM provided from the emission driver 1070. In some embodiments, each pixel PX may emit light when the emission signal EM has a low level, and thus an emission period of the pixel PX may correspond to a low period of the emission signal EM, but is not limited thereto. Further, each pixel PX may include a light-emitting element, and the display panel 1010 may be a light-emitting display panel. In some embodiments, the light-emitting element may be, but is not limited to, a micro light-emitting diode. In other embodiments, the light-emitting element may be an organic light-emitting diode (“OLED”), a nano light-emitting diode (“NED”), a quantum dot (“QD”) light-emitting diode, an inorganic light-emitting diode, or any other suitable light-emitting element.

The data driver 1030 may generate the data signals DS based on a data control signal DCTRL and output image data ODAT received from the controller 1090, and may provide the data signals DS to the plurality of pixels PX through the data lines. In some embodiments, the data control signal DCTRL may include, but is not limited to, an output data enable signal, a horizontal start signal and a load signal. In some embodiments, the data driver 1030 and the controller 1090 may be implemented as a single integrated circuit, and the single integrated circuit may be also referred to as a timing controller embedded data driver (“TED”) integrated circuit. In other embodiments, the data driver 1030 and the controller 1090 may be implemented as separate integrated circuits.

The scan driver 1050 may generate the scan signals SS based on a scan control signal SCTRL received from the controller 1090, and may sequentially provide the scan signals SS to the plurality of pixels PX through the scan lines on a row-by-row basis. In some embodiments, the scan control signal SCTRL may include, but is not limited to, a signal and a scan clock signal. Further, in some embodiments, the scan driver 1050 may be integrated or formed in the display panel 1010. In other embodiments, the scan driver 1050 may be implemented with one or more integrated circuits.

The emission driver 1070 may generate the emission signals EM based on an emission control signal EMCTRL received from the controller 1090, and may sequentially provide the emission signals EM to the plurality of pixels PX through the light-emitting lines on a row-by-row basis. In some embodiments, the emission control signal EMCTRL may include, but is not limited to, a start signal FLM, a first clock signal CLK1 and a second clock signal CLK2. The emission driver 1070 may include a plurality of stages STG1, STG2, STG3, STG4, etc. illustrated in FIG. 1 that sequentially provides the emission signals EM to the plurality of pixels PX. In some embodiments, as illustrated in FIG. 1, odd-numbered stages STG1, STG3, etc., of the emission driver 1070 (or output circuits of the odd-numbered stages STG1, STG3, etc.) may receive a low gate voltage VGL in a first mode MODE1, and may receive the second clock signal CLK2 in a second mode MODE2. Further, even-numbered stages STG2, STG4, etc., of the emission driver 1070 (or output circuits of the even-numbered stages STG2, STG4, etc.) may receive the low gate voltage VGL in the first mode MODE1, and may receive the first clock signal CLK1 in the second mode MODE2. Accordingly, the emission driver 1070 may output the emission signals EM having a low period longer than or equal to two horizontal time periods in the first mode MODE1, and may output the emission signals EM having a low period shorter than or equal to one horizontal time period in the second mode MODE2. Further, in some embodiments, the emission driver 1070 may be integrated or formed in the display panel 1010. In other embodiments, the emission driver 1070 may be implemented with one or more integrated circuits.

The controller 1090 (e.g., a timing controller) may receive input image data IDAT and a control signal CTRL from an external processor (e.g., a graphics processing unit (“GPU”), an application processor (“AP”) or a graphics card). In some embodiments, the input image data IDAT may be red, green and blue (“RGB”) image data including red image data, green image data and blue image data. The control signal CTRL may include a DBV representing a luminance of the display device 1000 corresponding to the maximum gray level (e.g., a 255-gray level). In some embodiments, the controller 1090 may determine a mode of the display device 1000 as the first mode MODE1 when the DBV is greater than or equal to a reference brightness value, and may determine the mode of the display device 1000 as the second mode MODE2 when the DBV is less than the reference brightness value. In the first mode MODE1, the controller 1090 may provide the emission driver 1070 with the start signal FLM having a low period longer than or equal to two horizontal time periods, and may provide the low gate voltage VGL to the output circuits of the plurality of stages STG1, STG2, STG3, STG4, etc., of the emission driver 1070. Further, in the second mode MODE2, the controller 1090 may provide the emission driver 1070 with the start signal FLM having a low period shorter than or equal to one horizontal time period, may provide the second clock signal CLK2 to the output circuits of the odd-numbered stages STG1, STG3, etc., and may provide the first clock signal CLK1 to the output circuits of the even-numbered stages STG2, STG4, etc. In some embodiments, the control signal CTRL may further include, but is not limited to, a vertical synchronization signal, a horizontal synchronization signal, an input data enable signal, a master clock signal, etc. The controller 1090 may generate the output image data ODAT, the data control signal DCTRL, the scan control signal SCTRL and the emission control signal EMCTRL based on the input image data IDAT and the control signal CTRL. The controller 1090 may control an operation of the data driver 1030 by providing the output image data ODAT and the data control signal DCTRL to the data driver 1030, may control an operation of the scan driver 1050 by providing the scan control signal SCTRL to the scan driver 1050, and may control an operation of the emission driver 1070 by providing the emission control signal EMCTRL to the emission driver 1070.

In the display device 1000 in embodiments, the output circuit of at least one stage of the emission driver 1070 may output the low gate voltage VGL as the emission signal EM in the first mode MODE1, and may output a clock signal (e.g., the first clock signal CLK1 or the second clock signal CLK2) as the emission signal EM in the second mode MODE2. Accordingly, the emission driver 1070 may normally operate not only in the first mode MODE1 (e.g., a high luminance mode) in which an on-period (e.g., a low period) of the emission signal EM is longer than or equal to two horizontal time periods, but also in the second mode MODE2 (e.g., a low luminance mode) in which the on-period of the emission signal EM is shorter than one horizontal time period.

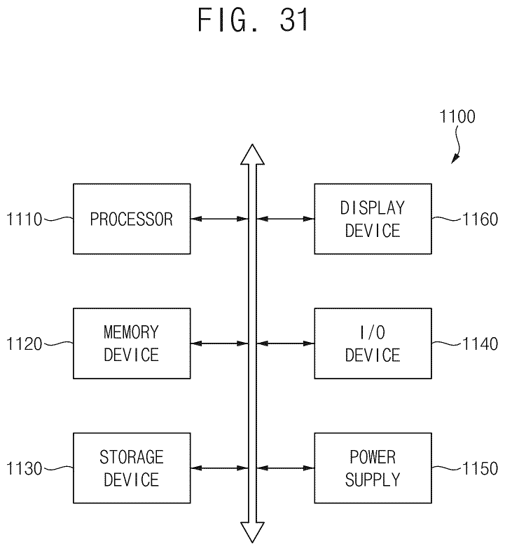

FIG. 31 is a block diagram illustrating an embodiment of an electronic device including a display device.

Referring to FIG. 31, an electronic device 1100 may include a processor 1110, a memory device 1120, a storage device 1130, an input/output (“I/O”) device 1140, a power supply 1150 and a display device 1160. The electronic device 1100 may further include a plurality of ports for communicating with a video card, a sound card, a memory card, a universal serial bus (“USB”) device, other electric devices, etc.

The processor 1110 may perform various computing functions or tasks. The processor 1110 may be an application processor (“AP”), a micro-processor, a central processing unit (“CPU”), etc. The processor 1110 may be coupled to other components via an address bus, a control bus, a data bus, etc. Further, in some embodiments, the processor 1110 may be further coupled to an extended bus such as a peripheral component interconnection (“PCI”) bus.

The memory device 1120 may store data for operations of the electronic device 1100. In an embodiment, the memory device 1120 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device such as a dynamic random access memory (“DRAM”) device, a static random access memory (“SRAM”) device, a mobile dynamic random access memory (“mobile DRAM”) device, etc., for example.

The storage device 1130 may be a solid state drive (“SSD”) device, a hard disk drive (“HDD”) device, a compact disc-read only memory (“CD-ROM”) device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through the buses or other communication links.

In the display device 1160, an output circuit of at least one stage of an emission driver may output a low gate voltage as an emission signal in a first mode (e.g., a high luminance mode), and may output a clock signal as the emission signal in a second mode (e.g., a low luminance mode). Accordingly, the emission driver may be suitable for not only the high luminance mode in which an on-period (e.g., a low period) of the emission signal is longer than or equal to two horizontal time periods, but also the low luminance mode in which the on-period of the emission signal is shorter than or equal to one horizontal time period.

The inventive concepts may be applied any electronic device 1100 including the display device 1160. In an embodiment, the inventive concepts may be applied to a virtual reality (“VR”) device, an augmented reality (“AR”) device, a mixed reality (“MR”) device, an extended reality (“XR”) device, a mobile phone, a smart phone, a television (“TV”) (e.g., a digital TV, a three-dimensional (“3D”) TV, etc.), a wearable electronic device, a personal computer (“PC”) (e.g. a laptop computer, a tablet computer, etc.), a home appliance, a personal digital assistant (“PDA”), a portable multimedia player (“PMP”), a digital camera, a music player, a portable game console, a navigation device, etc., for example.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. Therefore, it is to be understood that the foregoing is illustrative of various embodiments and is not to be construed as limited to the illustrative embodiments disclosed, and that modifications to the disclosed embodiments, as well as other embodiments, are intended to be included within the scope of the appended claims.

What is claimed is:

1. An emission driver including a plurality of stages, a stage of the plurality of stages comprising:
an input circuit configured to transfer an input signal to a first node in response to a first clock signal;
a node separation circuit connected between the first node and a second node, and configured to receive a low gate voltage having a first voltage level;
a node control circuit configured to control a voltage of a third node based on a voltage of the first node, a high gate voltage having a second voltage level higher than the first voltage level and the low gate voltage; and
an output circuit configured to output the high gate voltage as an emission signal in response to the voltage of the third node, to output the low gate voltage as the emission signal in response to a voltage of the second node in a first mode, and to output a second clock signal different from the first clock signal as the emission signal in response to the voltage of the second node in a second mode.

2. The emission driver of claim 1, wherein the output circuit outputs the emission signal having a low period, in which the emission signal has the first voltage level, longer than or equal to two horizontal time periods in the first mode, and outputs the emission signal having a low period shorter than or equal to one horizontal time period in the second mode.

3. The emission driver of claim 1, wherein the first mode is a high luminance mode in which a display brightness value is greater than or equal to a reference value, and
wherein the second mode is a low luminance mode in which the display brightness value is less than the reference value.

4. The emission driver of claim 1, wherein the second clock signal is delayed by half a clock period from the first clock signal.

5. The emission driver of claim 4, wherein the clock period corresponds to two horizontal time periods, and
wherein the second clock signal is delayed by one horizontal time period from the first clock signal.

6. The emission driver of claim 1, wherein the input circuit includes:
a first transistor including a gate which receives the first clock signal, a first terminal which receives the input signal, and a second terminal connected to the first node.

7. The emission driver of claim 1, wherein the node separation circuit includes:
a second transistor including a gate which receives the low gate voltage, a first terminal connected to the first node, and a second terminal connected to the second node.

8. The emission driver of claim 1, wherein the output circuit includes:
a third transistor including a gate connected to the third node, a first terminal which receives the high gate voltage, and a second terminal connected to an output node from which the emission signal is output;
a first capacitor including a first electrode connected to the second node, and a second electrode connected to the output node; and
a fourth transistor including a gate connected to the second node, a first terminal connected to the output node, and a second terminal which receives the low gate voltage in the first mode and receives the second clock signal in the second mode.

9. The emission driver of claim 1, wherein the node control circuit includes:
a fifth transistor including a gate connected to the first node, a first terminal which receives the high gate voltage, and a second terminal connected to the third node;
a sixth transistor including a gate connected to the second node, a first terminal connected to the third node, and a second terminal which receives the low gate voltage; and
a second capacitor including a first electrode which receives the high gate voltage, and a second electrode connected to the third node.

10. The emission driver of claim 9, wherein the fifth transistor is a P-type metal-oxide-semiconductor transistor, and
wherein the sixth transistor is an N-type metal-oxide-semiconductor transistor.

11. The emission driver of claim 9, wherein the stage further comprises:
a carry circuit configured to output the high gate voltage as a carry signal in response to the voltage of the third node, to output the low gate voltage as the carry signal in response to the voltage of the second node in the first mode, and to output the second clock signal as the carry signal in response to the voltage of the second node in the second mode.

12. The emission driver of claim 11, wherein the carry circuit includes:
a seventh transistor including a gate connected to the third node, a first terminal which receives the high gate voltage, and a second terminal connected to a carry node from which the carry signal is output; and
an eighth transistor including a gate connected to the second node, a first terminal connected to the carry node, and a second terminal which receives the low gate voltage in the first mode and receives the second clock signal in the second mode.

13. The emission driver of claim 1, wherein the stage further comprises:
a carry circuit configured to output the high gate voltage as a carry signal in response to the voltage of the third node, to output a small low gate voltage having an absolute value less than an absolute value of the low gate voltage as the carry signal in response to the voltage of the second node in the first mode, and to output a third clock signal as the carry signal in response to the voltage of the second node in the second mode, and
wherein the third clock signal has a phase substantially equal to a phase of the second clock signal, and has the small low gate voltage as a low voltage.

14. The emission driver of claim 1, wherein the node control circuit includes:
a fifth transistor configured to apply the high gate voltage to a fourth node in response to the input signal;
a sixth transistor configured to apply the first clock signal to the third node in response to a voltage of the fourth node;
a third capacitor including a first electrode connected to the fourth node, and a second electrode which receives the first clock signal;
a seventh transistor configured to be turned off in the first mode, and to apply the first clock signal to the third node in the second mode;
an eighth transistor configured to be turned on in the first mode, and to be turned off in the second mode;
a ninth transistor connected in series with the eighth transistor between a line which transfers the high gate voltage and the third node, and configured to apply the high gate voltage to the third node in response to the voltage of the first node in the first mode; and
a second capacitor including a first electrode which receives the high gate voltage, and a second electrode connected to the third node.

15. The emission driver of claim 14, wherein the fifth transistor includes a gate which receives the input signal, a first terminal which receives the high gate voltage, and a second terminal connected to the fourth node,
wherein the sixth transistor includes a gate connected to the fourth node, a first terminal connected to the third node, and a second terminal which receives the first clock signal,
wherein the seventh transistor includes a gate which receives the high gate voltage in the first mode and receives the low gate voltage in the second mode, a first terminal connected to the third node, and a second terminal which receives the first clock signal,
wherein the eighth transistor includes a gate which receives the low gate voltage in the first mode and receives the high gate voltage in the second mode, a first terminal which receives the high gate voltage, and a second terminal, and
wherein the ninth transistor includes a gate connected to the first node, a first terminal connected to the second terminal of the eighth transistor, and a second terminal connected to the third node.

16. The emission driver of claim 15, wherein the fifth, sixth, seventh, eighth and ninth transistors are P-type metal-oxide-semiconductor transistors.

17. An electronic device comprising:
a processor configured to provide input image data; and
a display device configured to receive the input image data from the processor, and to display an image based on the input image data, the display device comprising:
a display panel including a plurality of pixels;
a data driver configured to provide data signals to the plurality of pixels;
a scan driver configured to provide scan signals to the plurality of pixels;
an emission driver including a plurality of stages which sequentially provide emission signals to the plurality of pixels, a stage of the plurality of stages comprising:
an input circuit configured to transfer an input signal to a first node in response to a first clock signal;
a node separation circuit connected between the first node and a second node, and configured to receive a low gate voltage having a first voltage level;
a node control circuit configured to control a voltage of a third node based on a voltage of the first node, a high gate voltage having a second voltage level higher than the first voltage level and the low gate voltage; and
an output circuit configured to output the high gate voltage as a corresponding emission signal among the emission signals in response to the voltage of the third node, to output the low gate voltage as the corresponding emission signal in response to a voltage of the second node in a first mode, and to output a second clock signal different from the first clock signal as the corresponding emission signal in response to the voltage of the second node in a second mode; and
a controller configured to control the data driver, the scan driver and the emission driver.

18. The electronic device of claim 17, wherein the controller receives a display brightness value, determines a mode of the display device as the first mode when the display brightness value is greater than or equal to a reference brightness value, and determines the mode of the display device as the second mode when the display brightness value is less than the reference brightness value.

19. The electronic device of claim 17, wherein the controller provides the emission driver with a start signal having a low period, in which the emission signals have the first voltage level, longer than or equal to two horizontal time periods in the first mode, and provides the emission driver with the start signal having a low period shorter than or equal to one horizontal time period in the second mode.

20. The electronic device of claim 17, wherein, in the first mode, the controller provides the low gate voltage to output circuits of the plurality of stages, and
wherein, in the second mode, the controller provides one of the first clock signal and the second clock signal to output circuits of odd-numbered stages among the output circuits of the plurality of stages, and provides a remaining one of the first clock signal and the second clock signal to output circuits of even-numbered stages among the output circuits of the plurality of stages.
